(19) United States
(12) Patent Application Publication
(10) Pub. No.: US 2018/0052269 A1
(43) Pub. Date: Feb. 22, 2018

(54) POLARIZING FILM AND METHOD FOR MANUFACTURING SAME, OPTICAL FILM, AND IMAGE DISPLAY DEVICE

(71) Applicant: NITTO DENKO CORPORATION, Ibaraki-shi, Osaka (JP)

(72) Inventors: Takeshi Saito, Ibaraki-shi (JP); Yoshihiro Nishitani, Ibaraki-shi (JP); Tetsurou Ikeda, Ibaraki-shi (JP)

(73) Assignee: NITTO DENKO CORPORATION, Ibaraki-shi, Osaka (JP)

(21) Appl. No.: 15/557,253

(22) PCT Filed: Mar. 11, 2016
(86) PCT No.: PCT/JP2016/057699

§ 371 Date: Sep. 11, 2017

(30) Foreign Application Priority Data
Mar. 12, 2015 (JP) 2015-049509
Mar. 9, 2016 (JP) 2016-045288

(51) Int. Cl. G02B 5/30; C09J 7/02; C08G 59/50; C08J 5/18

(52) U.S. Cl. CPC G02B 5/3025; C08J 5/18; C08G 59/5006; C09J 7/0239

(57) ABSTRACT

A polarizing film comprising a polarizer and a cured resin layer formed on at least one surface of the polarizer by curing a curable resin composition, wherein
the curable resin composition contains a compound represented by formula (1):

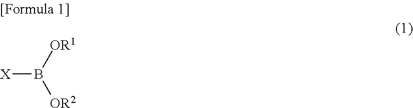

wherein x represents a functional group comprising a reactive group, and R¹ and R² each independently represent a hydrogen atom or an optionally substituted, aliphatic hydrocarbon, aryl, or heterocyclic group.

### TECHNICAL FIELD

The invention relates to a polarizing film including a polarizer and a cured resin layer formed on at least one surface of the polarizer by curing a curable resin composition. The polarizing film may be used alone or as part of a laminated optical film to form an image display device such as a liquid crystal display (LCD), an organic electroluminescent (EL) display, a cathode ray tube (CRT), or a plasma display panel (PDP).

### BACKGROUND ART

The liquid crystal display market has experienced rapid growth in many applications such as clocks, cellular phones, personal digital assistants (PDAs), notebook PCs, PC monitors, DVD players, and TVs. Liquid crystal display devices use liquid crystal switching to visualize the polarization state, and on the basis of the display principle, they use polarizers. Particularly in TV applications, higher brightness, higher contrast, and wider viewing angle are required, and polarizing films are also required to have higher transmittance, higher degree of polarization, and higher color reproducibility.

For example, iodine polarizers composed of stretched polyvinyl alcohol (hereinafter, also simply referred to as “PVA”) and iodine adsorbed thereto are most popular polarizers widely used because of their high transmittance and high degree of polarization. A polarizing film commonly used includes a polarizer and transparent protective films bonded to both sides of the polarizer with a solution of a polyvinyl alcohol-based material in water, what is called a water-based adhesive (Patent Document 1 listed below). Transparent protective films are made of a high water-vapor permeability material such as triacetyl cellulose. When the water-based adhesive is used (in what is called wet lamination), the lamination of the polarizer and the transparent protective films must be followed by a drying step.

On the other hand, active energy-ray curable adhesives are proposed as alternatives to the water-based adhesives. The process of producing polarizing films using active energy ray-curable adhesives requires no drying step and thus can improve the productivity of polarizing films. For example, the inventors have proposed a radically-polymerizable, active energy ray-curable, adhesive containing an N-substituted amide monomer as a curable component (Patent Document 2 listed below).

### PRIOR ART DOCUMENTS

### Patent Documents

### Patent Document 1: JP-A-2001-296427

### Patent Document 2: JP-A-2012-052000

### SUMMARY OF THE INVENTION

### Problems to be Solved by the Invention

The adhesive layer formed using the active energy ray-curable adhesive described in Patent Document 2 can sufficiently withstand a water resistance test in which, for example, the adhesive layer is immersed in hot water at 60° C. for 6 hours and then evaluated for the presence or absence of decoloration or peeling. Now, however, adhesives for polarizing films are being required to have further improved water resistance at such a level that they can withstand a severer water resistance test in which, for example, they are immersed in water (to saturation) and then subjected to the evaluation of whether or not they peel when scratched at edges with fingernail. In fact, therefore, adhesives for polarizing films, including the active energy ray-curable adhesive described in Patent Document 2 and those reported so far, are susceptible to further improvement in water resistance.

It is an object of the invention, which has been made in view of the above circumstances, to provide a polarizing film having a cured resin layer that has good adhesion to the polarizer and is highly water-resistant even under harsh conditions such as dewing environments and immersion in water.

Specifically, it is an object of the invention to provide a polarizing film that includes a polarizer, a cured resin layer as an adhesive layer, and a transparent protective film provided on at least one surface of the polarizer with the adhesive layer interposed therebetween, in which the adhesive layer provides good adhesion between the polarizer and the transparent protective film and has high water resistance. It is a further object of the invention to provide an optical film including such a polarizing film and to provide an image display device having such a polarizing film or such an optical film.

### Means for Solving the Problems

As a result of intensive studies to solve the problems, the inventors have accomplished the invention on the basis of the finding that the objects can be achieved by using a specific curable resin composition to form a cured resin layer on at least one surface of a polarizer.

Specifically, the invention is directed to a polarizing film including a polarizer and a cured resin layer formed on at least one surface of the polarizer by curing a curable resin composition, wherein

the curable resin composition contains a compound represented by formula (1):

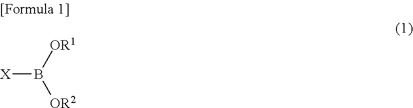

wherein X represents a functional group including a reactive group, and R¹ and R² each independently represent a hydrogen atom or an optionally substituted, aliphatic hydrocarbon, aryl, or heterocyclic group.

The compound represented by formula (1) is preferably represented by formula (1′):

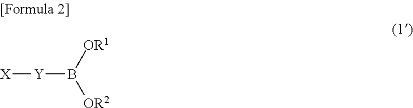

wherein Y is a phenylene group or an alkylene group, and X, R¹, and R² have the same meanings as defined above.

In the polarizing film, the compound represented by formula (1) preferably has hydrogen atoms for both R¹ and R².

In the polarizing film, the reactive group of the compound represented by formula (1) is preferably at least one reactive group selected from the group consisting of a vinyl group, a (meth)acrylic group, a styryl group, a (meth)acrylamide group, a vinyl ether group, an epoxy group, an oxetane group, and a mercapto group.

In the polarizing film, the curable resin composition preferably contains a compound represented by formula (2):

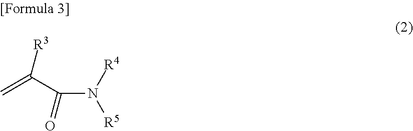

wherein R³ is a hydrogen atom or a methyl group, R⁴ and R⁵ are each independently a hydrogen atom, an alkyl group, a hydroxyalkyl group, an alkoxyalkyl group, or a cyclic ether group, and R⁴ and R⁵ may form a heterocyclic ring.

In the polarizing film, the cured resin layer is preferably an adhesive layer, and the polarizing film preferably further includes a transparent protective film provided on at least one surface of the polarizer with the adhesive layer interposed between the polarizer and the transparent protective film.

The invention is also directed to an optical film including a laminate including at least one piece of the polarizing film having any of the above features, or directed to an image display device including the polarizing film having any of the above features or including the optical film.

The invention is further directed to a method for manufacturing a polarizing film including a polarizer and a cured resin layer formed on at least one surface of the polarizer by curing a curable resin composition, the method including the steps of:

applying the curable resin composition to at least one surface of the polarizer; and

curing the curable resin composition with active energy rays applied from the polarizer surface side or the curable resin composition-coated surface side, wherein

the curable resin composition contains a compound represented by formula (1):

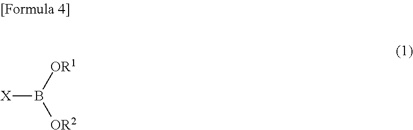

wherein X represents a functional group including a reactive group, and R¹ and R² each independently represent a hydrogen atom or an optionally substituted, aliphatic hydrocarbon, aryl, or heterocyclic group.

The compound represented by formula (1) is preferably represented by formula (1′):

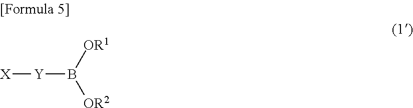

wherein Y is a phenylene group or an alkylene group, and X, R¹, and R² have the same meanings as defined above.

In the method for manufacturing a polarizing film, the cured resin layer is preferably an adhesive layer and the polarizing film preferably further includes a transparent protective film provided on at least one surface of the polarizer with the adhesive layer interposed between the polarizer and the transparent protective film, the method preferably including the steps of:

applying the curable resin composition to the surface of at least one of the polarizer and the transparent protective film;

laminating the polarizer and the transparent protective film; and

bonding the polarizer and the transparent protective film together with an adhesive layer formed therebetween by curing the curable resin composition with active energy rays applied from the polarizer surface side or the transparent protective film surface side.

### Effect of the Invention

When exposed to a dewing environment, a polarizing film including a polarizer and a cured resin layer disposed thereon may undergo delamination between the polarizer and the cured resin layer by the following mechanism. First, water diffuses into the cured resin layer and into the polarizer interface side. In a conventional polarizing film, where hydrogen bonds and/or ionic bonds greatly contribute to the adhering strength between the cured resin layer and the polarizer, the water diffusing to the polarizer interface side causes dissociation of hydrogen bonds and ionic bonds at the interface and thus reduces the adhering strength between the cured resin layer and the polarizer. In a dewing environment, this can cause delamination between the cured resin layer and the polarizer.

On the other hand, the polarizing film according to the invention has a cured resin layer formed by curing a curable resin composition containing a compound having a boric acid group and/or a boric ester group (the compound represented by formula (1)), in which the boric acid group and/or the boric ester group can easily form an ester bond particularly with the hydroxyl group of a polyvinyl alcohol-based polarizer. In addition, the compound represented by formula (1) further has a group X including a reactive group, through which other curable components in the curable resin composition can undergo reactions. Therefore, the boric acid group and/or the boric ester group of the cured resin layer can strongly bond to the hydroxyl group of the polarizer by forming a covalent bond therewith. Therefore, even when water exists at the interface between the polarizer and the cured resin layer, there is dramatically improved water resistance of adhesion between the polarizer and the cured resin layer because the polarizer and the cured resin layer strongly interact with each other not only through hydrogen bonds and/or ionic bonds but also through the covalent bonds.

When the compound represented by formula (1) has the reactive group bonded to the boric acid atom through a phenylene or alkylene group, the cured resin layer formed by curing the curable resin composition containing the compound can have significantly improved water-resistant adhesion to the polarizer. The reason for this may be as follows. As mentioned above, the boric acid group and/or the boric ester group of the compound represented by formula (1) can strongly bond to the hydroxyl group of a polyvinyl alcohol-based polarizer by reacting with the hydroxyl group. However, if the reactive group of the compound represented by formula (1) does not react with other curable components in the curable resin composition, the water resistance of the adhesion between the polarizer and the cured resin layer can finally fail to improve sufficiently. In this regard, the affinity between the compound represented by formula (1) and other curable components in the curable resin composition is not so high because the boric acid group and/or the boric ester group of the compound represented by formula (1) has hydrophilicity as well as the polarizer. However, when the compound represented by formula (1) has the reactive group bonded to the boric acid atom through a phenylene or alkylene group (when the compound is represented by formula (1′)), the phenylene or alkylene group can have an affinity for other curable components, so that when reacting with the polarizer and other materials, the reactive group of the compound represented by formula (1) can very efficiently react with other curable components. This can result in a dramatically improvement in the water resistance of the adhesion between the polarizer and the cured resin layer.

There are compounds having a boric acid group and/or a boric ester group and having a reactive group bonded to the boron atom through the oxygen atom bonded thereto (hereinafter such compounds will also be referred to as “B-O-bond-Containing compounds”). However, the degree of improvement of the water resistance of the adhesion by using a curable resin composition containing a B-O-bond-containing compound significantly differs from that by using the curable resin composition containing the compound having the reactive group bonded to the boric acid atom through a phenylene or alkylene group (hereinafter, also referred to as the “B-C-bond-containing compound”). This may be because (i) for example, in a dewing environment, the boron-oxygen bond in the B-O-bond-containing compound can easily undergo hydrolysis, which can degrade the water resistance of the adhesion of the resin layer formed after the curing, and (ii) the boron-carbon bond in the B-C-bond-containing compound has high resistance to hydrolysis even in a dewing environment. When the B-C-bond-containing compound is used, therefore, the resin layer formed after the curing can have dramatically improved water-resistant adhesion.

In addition, when having a transparent protective film provided on at least one surface of the polarizer with an adhesive layer interposed therebetween and formed as the cured resin layer using the curable resin composition, the polarizing film can have good optical durability (to a humidity durability test) even in a harsh humid environment (e.g., at 85° C. and 85% RH). Therefore, even when placed in such a harsh humid environment, the polarizing film of the invention can be less vulnerable to degradation (change) of its transmittance or degree of polarization. In addition, the polarizing film of the invention resists degradation of adhering strength even in a harsh environment such as immersion in water, and can keep, at a low level, the reduction of the adhering strength between the polarizer and the transparent protective film (between the polarizer and the adhesive layer) even under environmental conditions involving severe contact with water.

### MODE FOR CARRYING OUT THE INVENTION

The polarizing film according to the invention includes a polarizer and a cured resin layer formed on at least one surface of the polarizer by curing a curable resin composition containing a compound represented by formula (1):

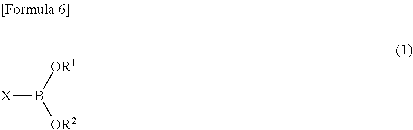

wherein X represents a functional group including a reactive group, and R¹ and R² each independently represent a hydrogen atom or an optionally substituted, aliphatic hydrocarbon, aryl, or heterocyclic group. The aliphatic hydrocarbon group may be an optionally substituted linear or branched alkyl group of 1 to 20 carbon atoms, an optionally substituted cyclic alkyl group of 3 to 20 carbon atoms, or an alkenyl group of 2 to 20 carbon atoms. The aryl group may be, for example, an optionally substituted phenyl group of 6 to 20 carbon atoms or an optionally substituted naphthyl group of 10 to 20 carbon atoms. The heterocyclic group may be, for example, an optionally substituted five- or six-membered ring group containing at least one heteroatom. These groups may be linked together to form a ring. In formula (1), R¹ and R² are each preferably a hydrogen atom or a linear or branched alkyl group of 1 to 3 carbon atoms, most preferably a hydrogen atom.

In the compound represented by formula (1), X is a functional group including a reactive group. The functional group can react with other curable components in the curable resin composition. The reactive group in the group X may be, for example, hydroxyl, amino, aldehyde, carboxyl, vinyl, (meth)acrylic, styryl, (meth)acrylamide, vinyl ether, epoxy, or oxetane. When the curable resin composition used in the invention is active energy ray-curable, the reactive group in the group X is preferably at least one reactive group selected from the group consisting of a vinyl group, a (meth)acrylic group, a styryl group, a (meth)acrylamide group, a vinyl ether group, an epoxy group, an oxetane group, and a mercapto group. Particularly when the curable resin composition is radically polymerizable, the reactive group in the group X is preferably at least one reactive group selected from the group consisting of a (meth)acrylic group, a styryl group, and a (meth)acrylamide group. When having a (meth)acrylamide group, the compound represented by formula (1) can be highly reactive and thus undergo high degree of copolymerization with the active energy ray-curable resin composition, which is more preferred. The (meth)acrylamide group is also preferred because it has high polarity and can produce good adhesion, which makes it possible to efficiently obtain the effects of the invention. When the curable resin composition used in the invention is cationically polymerizable, the reactive group in the group X preferably has at least one functional group selected from a hydroxyl group, an amino group, an aldehyde group, a carboxyl group, a vinyl ether group, an epoxy group, an oxetane group, and a mercapto group. In particular, the reactive group preferably has an epoxy group, so that the resulting cured resin layer can have high tackiness to the adherend, and the reactive group preferably has a vinyl ether group, so that the resulting curable resin composition can have good curing properties.

A preferred example of the compound represented by formula (1) is a compound represented by formula (1′):

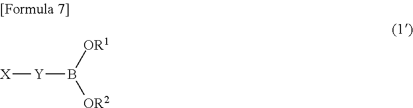

wherein Y is a phenylene group or an alkylene group, and X, R¹, and R² have the same meanings as defined above. More preferred examples of the compound represented by formula (1) include compounds (1a), (1b), (1c), and (1d) shown below.

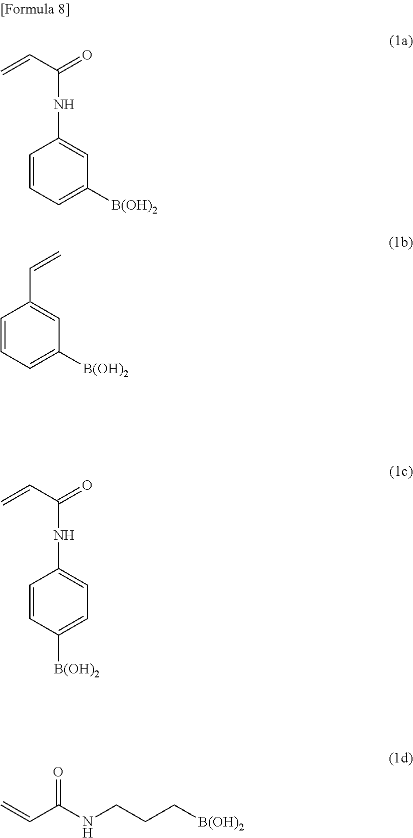

In the invention, the compound represented by formula (1) may have the reactive group directly bonded to the boron atom. As shown in the above examples, however, the compound represented by formula (1) preferably has the reactive group and the boron atom bonded together with a phenylene or alkylene group between them. In other words, the compound represented by formula (1) is preferably represented by formula (1′). If the compound represented by formula (1) has the reactive group bonded to the boron atom with an oxygen atom between them, the adhesive layer obtained by curing the curable resin composition containing the compound represented by formula (1) may tend to have degraded water-resistant adhesion. On the other hand, in a preferred mode, the compound represented by formula (1) can improve the water-resistant adhesion when having the reactive group bonded to the boron atom with a phenylene or alkylene group between them, in other words, when having the reactive group together with a boron-carbon bond (as in the case of formula (1′)) rather than a boron-oxygen bond. In the invention, the compound represented by formula (1) also preferably has the reactive group and the boron atom bonded together with an optionally substituted organic group of 1 to 20 carbon atoms between them, which can also improve the water-resistant adhesion of the adhesive layer obtained after the curing. The optionally substituted organic group of 1 to 20 carbon atoms may be, for example, an optionally substituted linear or branched alkylene group of 1 to 20 carbon atoms, an optionally substituted cyclic alkylene group of 3 to 20 carbon atoms, an optionally substituted phenylene group of 6 to 20 carbon atoms, or an optionally substituted naphthylene group of 10 to 20 carbon atoms.

Besides the compounds listed above, examples of the compound represented by formula (1) may also include an ester of boric acid and hydroxyethylacrylamide, an ester of boric acid and methylolacrylamide, an ester of boric acid and hydroxyethyl acrylate, an ester of boric acid and hydroxybutyl acrylate, and other esters of boric acid and (meth)acrylates.

The content of the compound represented by formula (1) in the curable resin composition is preferably from 0.001 to 50% by weight, more preferably from 0.1 to 30% by weight, most preferably from 1 to 10% by weight, in order to improve the adhesion and the water-resistant adhesion between the polarizer and the cured resin layer, specifically, in order to improve the adhesion and the water-resistant adhesion between the polarizer and a transparent protective film bonded together with the adhesive layer interposed therebetween.

<Other Curable Components>

In the invention, the cured resin layer is formed by curing the curable resin composition including at least the compound represented by formula (1) and further including any other curable component or components. The mode of curing the curable resin composition can be broadly classified into thermosetting and active energy ray curing. The thermosetting resin may be, for example, a polyvinyl alcohol resin, an epoxy resin, an unsaturated polyester, a urethane resin, an acrylic resin, a urea resin, a melamine resin, or a phenolic resin, if necessary, which may be used in combination with a curing agent. The thermosetting resin is more preferably a polyvinyl alcohol resin or an epoxy resin. The active energy ray-curable resin can be broadly classified into electron beam-curable, ultraviolet ray-curable, and visible ray-curable resins according to the type of active energy rays. The composition can also be classified into a radically polymerizable curable resin composition and a cationically polymerizable resin composition according to the mode of curing. In the invention, active energy rays in the wavelength range of 10 nm to less than 380 nm are referred to as ultraviolet rays, and active energy rays in the wavelength range of 380 nm to 800 nm are referred to as visible rays.

For the polarizing film production according to the invention, the composition is preferably active energy ray-curable as mentioned above. The composition is more preferably visible ray-curable, which can be cured using visible rays in the range of 380 nm to 450 nm.

<1: Radically Polymerizable Curable Resin Compositions>

Curable components other than the compound represented by formula (1) may be, for example, radically polymerizable compounds for use in radically polymerizable curable resin compositions. The radically polymerizable compounds include compounds having a carbon-carbon double bond-containing radically polymerizable functional group, such as a (meth)acryloyl or vinyl group. The curable components may also be any of monofunctional and di- or polyfunctional radically-polymerizable compounds. These radically polymerizable compounds may be used singly or in combination of two or more. These radically polymerizable compounds are preferably, for example, (meth)acryloyl group-containing compounds. As used herein, the term “(meth)acryloyl” means an acryloyl group and/or a methacryloyl group, and hereinafter, “(meth)” will be used in the same meaning.

<<Monofunctional Radically Polymerizable Compound>>

The monofunctional radically polymerizable compound may be, for example, a compound represented by formula (2):

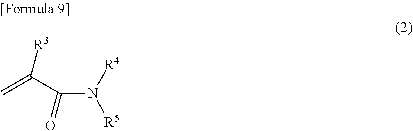

wherein R³ is a hydrogen atom or a methyl group, R⁴ and R⁵ are each independently a hydrogen atom, an alkyl group, a hydroxyalkyl group, an alkoxyalkyl group, or a cyclic ether group, and R⁴ and R⁵ may form a heterocyclic ring. The number of carbon atoms in the alkyl moiety of the alkyl group, the hydroxyalkyl group, and/or the alkoxyalkyl group is typically, but not limited to, 1 to 4. The heterocyclic ring optionally formed by R⁴ and R⁵ may be, for example, N-acryloylmorpholine. In the invention, a compound having both the structure represented by formula (1) and the structure represented by formula (2) is categorized as the compound represented by formula (1).

Examples of the compound represented by formula (2) include N-alkyl group-containing (meth)acrylamide derivatives such as N-methyl(meth)acrylamide, N,N-dimethyl(meth)acrylamide. N,N-diethyl(meth)acrylamide, N-isopropyl(meth)acrylamide, N-butyl(meth)acrylamide, and N-hexyl(meth)acrylamide; N-hydroxyalkyl group-containing (meth)acrylamide derivatives such as N-methylol(meth)acrylamide, N-hydroxyethyl(meth)acrylamide, and N-methylol-N-propane(meth)acrylamide; and N-alkoxy group-containing (meth)acrylamide derivatives such as N-methoxymethylacrylamide and N-ethoxymethylacrylamide. Examples also include cyclic ether group-containing (meth)acrylamide derivatives including heterocyclic ring-containing (meth)acrylamide derivatives, in which the nitrogen atom of the (meth)acrylamide group forms a heterocyclic ring, such as N-acryloylmorpholine, N-acryloylpiperidine, N-methacryloylpiperidine, and N-acryloylpyrrolidine. Among them, N-hydroxyethylacrylamide and N-acryloylmorpholine are preferably used because they are highly reactive, can form a cured product with a high elastic modulus, and can produce good adhesion to polarizers.

The content of the compound represented by formula (2) in the curable resin composition is preferably from 0.01 to 80% by weight, more preferably from 5 to 40% by weight, in order to form a cured resin layer with improved water resistance and improved adhesion to polarizers, particularly, in order to improve the adhesion and water resistance of the adhesive layer used to bond the polarizer and a transparent protective film.

The curable resin composition used in the invention may also contain another monofunctional radically polymerizable compound as a curable component other than the compound represented by formula (2). Examples of such a monofunctional radically polymerizable compound include various (meth)acrylic acid derivatives having a (meth)acryloyloxy group. Specific examples include methyl(meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, sec-butyl (meth)acrylate, tert-butyl (meth)acrylate, n-pentyl (meth)acrylate, tert-pentyl (meth)acrylate. 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, n-octadecyl (meth)acrylate, and other C1-C20alkyl (meth)acrylates.

Examples of the (meth)acrylic acid derivatives also include cycloalkyl (meth)acrylates such as cyclohexyl (meth)acrylate and cyclopentyl (meth)acrylate; aralkyl (meth)acrylates such as benzyl (meth)acrylate; polycyclic (meth)acrylates such as 2-isobornyl (meth)acrylate, 2-norbornylmethyl (meth)acrylate, 5-norbornene-2-yl-methyl (meth)acrylate, 3-methyl-2-norbornylmethyl (meth)acrylate, dicyclopentenyl (meth)acrylate, dicyclopentenyloxyethyl (meth)acrylate, and dicyclopentanyl (meth)acrylate; and alkoxy or phenoxy group-containing (meth)acrylates such as 2-methoxyethyl (meth)acrylate, 2-ethoxyethyl (meth)acrylate, 2-methoxyxmethoxyethyl (meth)acrylate, 3-methoxybutyl (meth)acrylate, ethyl carbitol (meth)acrylate, phenoxyethyl (meth)acrylate, and alkylphenoxy polyethylene glycol (meth)acrylate. Among them, dicyclopentenyloxyethyl acrylate and phenoxyethyl acrylate are preferred because they can produce good adhesion to various protective films.

Examples of the (meth)acrylic acid derivatives also include hydroxyl group-containing (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate. 6-hydroxyhexyl (meth)acrylate, 8-hydroxyoctyl (meth)acrylate, 10-hydroxydecyl (meth)acrylate, 12-hydroxylauryl (meth)acrylate, other hydroxyalkyl (meth)acrylates, [4-(hydroxymethyl)cyclohexyl]methyl acrylate, cyclohexanedimethanol mono(meth)acrylate, and 2-hydroxy-3-phenoxypropyl (meth)acrylate; epoxy group-containing (meth)acrylates such as glycidyl (meth)acrylate and 4-hydroxybutyl (meth)acrylate glycidyl ether; halogen-containing (meth)acrylates such as 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, heptadecafluorodecyl (meth)acrylate, and 3-chloro-2-hydroxypropyl (meth)acrylate; alkylaminoalkyl (meth)acrylates such as dimethylaminoethyl (meth)acrylate; oxetane group-containing (meth)acrylates such as 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, and 3-hexyl-oxetanylmethyl (meth)acrylate; heterocyclic ring-containing (meth)acrylates such as tetrahydrofurfuryl (meth)acrylate and butyrolactone (meth)acrylate; and (meth)acrylic acid adducts of neopentylglycol hydroxypivalate, and p-phenylphenol (meth)acrylate. Among them, 2-hydroxy-3-phenoxypropyl acrylate is preferred because it can produce good adhesion to various protective films.

Examples of the monofunctional radically polymerizable compound also include carboxyl group-containing monomers such as (meth)acrylic acid, carboxyethyl acrylate, carboxypentyl acrylate, itaconic acid, maleic acid, fumaric acid, crotonic acid, and isocrotonic acid.

Examples of the monofunctional radically polymerizable compound also include vinyl lactam monomers such as N-vinylpyrrolidone, N-vinyl-ε-caprolactam, and methylvinylpyrrolidone; and nitrogen-containing-heterocyclic ring-containing vinyl monomers such as vinylpyridine, vinylpiperidone, vinylpyrimidine, vinylpiperazine, vinylpyrazine, vinylpyrrole, vinylimidazole, vinyloxazole, and vinylmorpholine.

The curable resin composition used in the invention can provide improved adhesion to various substrates when containing, for example, a hydroxyl group-containing (meth)acrylate, a carboxyl group-containing (meth)acrylate, or a phosphate group-containing (meth)acrylate, which has particularly high polarity among the monofunctional radically polymerizable compounds. The content of the hydroxyl group-containing (meth)acrylate is preferably from 1% by weight to 30% by weight based on the weight of the resin composition. If the content is too high, the resulting cured product may have high water absorption rate, which may degrade water resistance. The content of the carboxyl group-containing (meth)acrylate is preferably from 1% by weight to 20% by weight based on the weight of the resin composition. Too high a carboxyl group-containing (meth)acrylate content may cause a reduction in the optical durability of the polarizing film and thus is not preferred. The phosphate group-containing (meth)acrylate may be 2-(meth)acryloyloxyethyl acid phosphate. The content of the phosphate group-containing (meth)acrylate is preferably from 0.1% by weight to 10% by weight based on the weight of the resin composition. Too high a phosphate group-containing (meth)acrylate content may cause a reduction in the optical durability of the polarizing film and thus is not preferred.

A radically polymerizable compound having an active methylene group may also be used as the monofunctional radically polymerizable compound. The radically polymerizable compound having an active methylene group should be a compound having an active double-bond group such as a (meth)acrylic group at its end or in its molecule and also having an active methylene group. The active methylene group may be, for example, an acetoacetyl group, an alkoxymalonyl group, or a cyanoacetyl group. The active methylene group is preferably an acetoacetyl group. Examples of the radically polymerizable compound having an active methylene group include acetoacetoxyalkyl (meth)acrylates such as 2-acetoacetoxyethyl (meth)acrylate, 2-acetoacetoxypropyl (meth)acrylate, and 2-acetoacetoxy-1-methylethyl (meth)acrylate; 2-ethoxymalonyloxyethyl (meth)acrylate, 2-cyanoacetoxyethyl (meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radically polymerizable compound having an active methylene group is preferably an acetoacetoxyalkyl (meth)acrylate.

“Polyfunctional Radically Polymerizable Compound”

Examples of the di- or polyfunctional radically polymerizable compound include polyfunctional (meth)acrylamide derivatives such as N,N′-methylenebis(meth)acrylamide, tripropylene glycol di(meth)acrylate, tetraethylene glycol di(meth)acrylate, 1,6-hexanediol di(meth)acrylate, 1,9-nonanediol di(meth)acrylate, 1,10-decanediol diacrylate, 2-ethyl-2-butylpropanediol di(meth)acrylate, bisphenol A di(meth)acrylate, bisphenol A ethylene oxide adduct di(meth)acrylate, bisphenol A propylene oxide adduct di(meth)acrylate, bisphenol A diglycidyl ether di(meth)acrylate, neopentyl glycol di(meth)acrylate, tricyclodecanedimethanol di(meth)acrylate, cyclic trimethylolpropane formal (meth)acrylate, dioxane glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, esters of (meth)acrylic acid with polyhydric alcohols, such as EO-modified diglycerin tetra(meth)acrylate, and 9,9-bis[4-(2-(meth)acryloyloxyethoxy)phenyl]fluorene. Specific preferred examples include Aronix M-220 (manufactured by Toagosei Co., Ltd.), LIGHT ACRYLATE 1,9ND-A (manufactured by Kyoeisha Chemical Co., Ltd.), LIGHT ACRYLATE DGE-4A (manufactured by Kyoeisha Chemical Co., Ltd.), LIGHT ACRYLATE DCP-A (manufactured by Kyoeisha Chemical Co., Ltd.), SR-531 (manufactured by Sartomer), and CD-536 (manufactured by Sartomer). If necessary, any of various epoxy (meth)acrylates, urethane (meth)acrylates, or polyester (meth)acrylates, or any of various (meth)acrylate monomers may also be used. The polyfunctional (meth)acrylamide derivative is preferably added to the curable resin composition because it can provide a high polymerization rate and good productivity and also can achieve good crosslinking properties when a cured product is made from the resin composition.

Radically polymerizable compounds should be used to achieve both good adhesion between the polarizer and any transparent protective film and good optical durability in a harsh environment. For this purpose, the monofunctional radically polymerizable compound is preferably used in combination with the polyfunctional radically polymerizable compound, in general, they are preferably used together in a ratio of 3 to 80% by weight of the monofunctional radically polymerizable compound to 20 to 97% by weight of the polyfunctional radically polymerizable compound based on 100% by weight of the radically polymerizable compounds.

<Features of the Radically Polymerizable Curable Resin Composition>

The curable resin composition used in the invention may be used as an active energy ray-curable resin composition when the curable component used is curable with active energy rays. When electron beams are used as the active energy rays, the active energy ray-curable resin composition does not need to contain any photopolymerization initiator. However, when ultraviolet or visible rays are used as the active energy rays, the active energy ray-curable resin composition preferably contains a photopolymerization initiator.

<<Photopolymerization Initiator>>

The photopolymerization initiator for use with the radially polymerizable compound is appropriately selected in a manner depending on the active energy rays. When ultraviolet or visible rays are used for curing, an ultraviolet or visible ray-cleavable photopolymerization initiator may be used. Examples of the photopolymerization initiator include benzophenone compounds such as benzil, benzophenone, benzoylbenzoic acid, and 3,3′-dimethyl-4-methoxybenzophenone; aromatic ketone compounds such as 4-(2-hydroxyethoxy)phenyl(2-hydroxy-2-propyl)ketone, α-hydroxy-α,α′-dimethylacetophenone, 2-methyl-2-hydroxypropiophenone, and α-hydroxycyclohexyl phenyl ketone; acetophenone compounds such as methoxyacetophenone, 2,2-dimethoxy-2-phenylacetophenone, 2,2-diethoxyacetophenone, and
2-methyl-1-[4-(methylthio)-phenyl]-2-morpholinopropane-1; benzoin ether compounds such as benzoin methyl ether, benzoin ethyl ether, benzoin isopropyl ether, benzoin butyl ether, and anisoin methyl ether; aromatic ketal compounds such as benzyl dimethyl ketal; aromatic sulfonyl chloride compounds such as 2-naphthalenesulfonyl chloride; optically active oxime compounds such as 1-phenone-1,1-propanedione-2-(o-ethoxycarbonyl)oxime; thioxanthone compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone; camphorquinone; halogenated ketones; acylphosphine oxide; and acylphosphonate.

The content of the photopolymerization initiator may be 20% by weight or less based on the total amount of the curable resin composition. The content of the photopolymerization initiator is preferably from 0.01 to 20% by weight, more preferably from 0.05 to 10% by weight, even more preferably from 0.1 to 5% by weight.

When the curable resin composition used in the invention is a visible ray-curable resin composition containing the radically polymerizable compound as a curable component, a photopolymerization initiator having high sensitivity to light of 380 nm or longer is preferably used in the composition. The photopolymerization initiator having high sensitivity to light of 380 nm or longer will be described later.

A compound represented by formula (3):

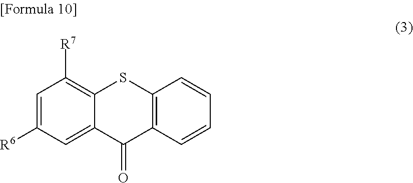

wherein R⁶ and R⁷ each represent —H, —CH₂CH₃, —i—Pr, or Cl, and R⁶ and R⁷ may be the same or different, is preferably used alone as the photopolymerization initiator, or the compound represented by formula (3) is preferably used as the photopolymerization initiator in combination with another photopolymerization initiator having high sensitivity to light of 380 nm or longer described below. The resulting adhesion is higher when the compound represented by formula (3) is used than when a photopolymerization initiator having high sensitivity to light of 380 nm or longer is used alone. In particular, the compound represented by formula (3) is preferably diethyl thioxanthone in which R⁶ and R⁷ are each —CH₂CH₃. The content of the compound represented by formula (3) in the curable resin composition is preferably from 0.1 to 5% by weight, more preferably from 0.5 to 4% by weight, even more preferably from 0.9 to 3% by weight, based on the total amount of the curable resin composition.

If necessary, a polymerization initiation aid is preferably added to the composition. In particular, the polymerization initiation aid is preferably triethylamine, diethylamine, N-methyldiethanolamine, ethanolamine, 4-dimethylaminobenzoic acid, methyl 4-dimethylaminobenzoate, ethyl 4-dimethylaminobenzoate, or isoamyl 4-dimethylaminobenzoate. Ethyl 4-dimethylaminobenzoate is particularly preferred, when the polymerization initiation aid is used, the content of the aid is generally 0 to 5% by weight, preferably 0 to 4% by weight, most preferably 0 to 3% by weight, based on the total amount of the curable resin composition.

If necessary, a known photopolymerization initiator may also be used in combination. Since the transparent protective film having the ability to absorb UV does not transmit light of 380 nm or shorter, such a photopolymerization initiator should preferably have high sensitivity to light of 380 nm or longer. Examples of such an initiator include 2-methyl-1-(4-methylthiophenyl)-2-morpholinopropan-1-one, 2-benzyl-2-dimethylamlno-1-(4-morpholinophenyl)-butanone-1,2-(dimethylamino)-2-[(4-methylphenyl)methyl]-1-[4-(4-morpho linyl)phenyl]-1-butanone, 2,4,6-trimethylbenzoyl-diphenyl-phosphine oxide, bis(2,4,6-trimethylbenzoyl)-phenylphosphine oxide, and bis(n5-2,4-cyclopentadien-1-yl)-bis(2,6-difluoro-3-(1H-pyrr ol-1-yl)-phenyl)titanium.

In particular, a compound represented by formula (4):

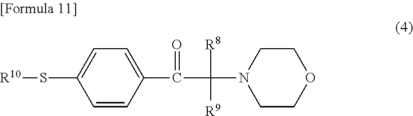

wherein R⁸, R⁹, and R¹⁰ each represent —H, —CH₃, —CH₂CH₃, —i—Pr, or Cl, and R⁸, R⁹, and R¹⁰ may be the same or different, is preferably used in addition to the photopolymerization initiator represented by formula (3). Commercially available 2-methyl-1-(4-methylthiophenyl)-2-morpholinopropan-1-one (IRGACURE 907 (trade name) manufactured by BASF) is advantageously used as the compound represented by formula (4). Besides this, 2-benzyl-2-dimethylamino-1-(4-morpholinophenyl)-butanone-1 (IRGACURE 369 (trade name) manufactured by BASF) and 2-(dimethylamino)-2-[(4-methylphenyl)methyl]-1-[4-(4-morpho linyl)phenyl]-1-butanone (IRGACURE 379 (trade name) manufactured by BASF) are preferred because of their high sensitivity.

<Radically Polymerizable Compound having Active Methylene Group and Radical Polymerization Initiator having Hydrogen-Withdrawing Function>

In the active energy ray-curable resin composition, the radically polymerizable compound having an active methylene group is preferably used in combination with a radical polymerization initiator having a hydrogen-withdrawing function. This feature can provide significantly improved adhesion for the adhesive layer of the polarizing film even immediately after the polarizing film is particularly taken out of a high-humidity environment or water (undried conditions). Although the reason for this is not clear, the following factors can be considered. The radically polymerizable compound having an active methylene group can be polymerized together with other radically polymerizable compounds used to form the adhesive layer. During the polymerization for forming the adhesive layer, the radically polymerizable compound having an active methylene group can be incorporated into the main chain and/or the side chain of the base polymer in the adhesive layer. When the radical polymerization initiator having a hydrogen-withdrawing function is present in this polymerization process, hydrogen can be withdrawn from the radically polymerizable compound having an active methylene group so that a radical can be generated on the methylene group in the process of forming the base polymer for the adhesive layer. The radical-carrying methylene group can react with hydroxyl groups in the polarizer including, for example, PVA, so that covalent bonds can be formed between the adhesive layer and the polarizer. This may result in a significant improvement in the adhesion of the adhesive layer of the polarizing film particularly even in an undried state.

In the invention, the radical polymerization initiator having a hydrogen-withdrawing function may be, for example, a thioxanthone radical polymerization initiator or a benzophenone radical polymerization initiator. The radical polymerization initiator is preferably a thioxanthone radical polymerization initiator. The thioxanthone radical polymerization initiator is preferably, for example, a compound represented by formula (3) above. Examples of the compound represented by formula (3) include thioxanthone, dimethyl thioxanthone, diethyl thioxanthone, isopropyl thioxanthone, and chlorothioxanthone. In particular, the compound represented by formula (3) is preferably diethyl thioxanthone in which R⁶ and R⁷ are each —CH₂CH₃.

When the active energy ray-curable resin composition contains the radically polymerizable compound having an active methylene group and the radical polymerization initiator having a hydrogen-withdrawing function, the composition preferably contains 1 to 50% by weight of the radically polymerizable compound having an active methylene group and 0.1 to 10% by weight of the radical polymerization initiator based on 100% by weight of the total amount of the curable components.

In the invention, as described above, the reaction of the radically polymerizable compound having an active methylene group in the presence of the radical polymerization initiator having a hydrogen-withdrawing function produces a radical on the methylene group, which reacts with the hydroxyl group of the polarizer including, for example, PVA to form a covalent bond. Thus, to produce a radical on the methylene group of the radically polymerizable compound having an active methylene group so that the covalent bond can be sufficiently formed, the composition preferably contains 1 to 50% by weight, more preferably 3 to 30% by weight of the radically polymerizable compound having an active methylene group based on 100% by weight of the total amount of the curable components. The content of the radically polymerizable compound having an active methylene group is preferably 1% by weight or more in order to sufficiently improve water resistance and to improve the adhesion under undried conditions. On the other hand, if the content is more than 50% by weight, the adhesive layer may be insufficiently cured. The curable resin composition preferably contains 0.1 to 10% by weight, more preferably 0.3 to 9% by weight of the radical polymerization initiator having a hydrogen-withdrawing function based on the total amount of the curable resin composition. To allow the hydrogen withdrawing reaction to proceed sufficiently, it is preferable to use 0.1% by weight or more of the radical polymerization initiator. On the other hand, if it is more than 10% by weight, the initiator may fail to dissolve completely in the composition.

<2: Cationically Polymerizable Curable Resin Composition>

The cationically polymerizable compound for use in the cationically polymerizable curable resin composition can be classified into a monofunctional cationically polymerizable compound having one cationically polymerizable functional group in the molecule and a polyfunctional cationically polymerizable compound having two or more cationically polymerizable functional groups in the molecule. The monofunctional cationically polymerizable compound has relatively low liquid viscosity and thus can reduce the liquid viscosity of the resin composition when added to the resin composition. Many monofunctional cationically polymerizable compounds have a functional group capable of serving various functions. When the resin composition contains any of such compounds, the resin composition and/or the curing product of the resin composition can have various functions. The polyfunctional cationically polymerizable compound, which can three-dimensionally crosslink the curing product of the resin composition, is preferably added to the resin composition. The monofunctional cationically polymerizable compound and the polyfunctional cationically polymerizable compound are preferably mixed in a ratio of 100 parts by weight of the former to 10 to 1,000 parts by weight of the latter. The cationically polymerizable functional group may be an epoxy group, an oxetanyl group, or a vinyl ether group. Examples of epoxy group-containing compounds include aliphatic epoxy compounds, alicyclic epoxy compounds, and aromatic epoxy compounds. Particularly, in the invention, the cationically polymerizable curable resin composition preferably contains an alicyclic epoxy compound, which can provide good curing properties and adhesion. Examples of such an alicyclic epoxy compound include 3,4-epoxycyclohexylmethyl-3,4-epoxycyclohexanecarboxylate and products obtained by modifying 3,4-epoxycyclohexylmethyl-3,4-epoxycyclohexanecarboxylate with caprolactone, trimethylcaprolactone, or valerolactone. Specific examples thereof include CELLOXIDE 2021, CELLOXIDE 2021A, CELLOXIDE 2021P, CELLOXIDE 2081, CELLOXIDE 2083, and CELLOXIDE 2085 (all manufactured by Daicel Corporation) and CYRACURE UVR-6105, CYRACURE UVR-6107, CYRACURE 30, and R-6110 (all manufactured by Dow Chemical Japan Limited). In the invention, the cationically polymerizable curable resin composition preferably contains an oxetanyl group-containing compound, which is effective in improving the curing properties of the composition or reducing the liquid viscosity of the composition. Examples of such an oxetanyl group-containing compound include 3-ethyl-3-hydroxymethyloxetane, 1,4-bis[(3-ethyl-3-oxetanyl)methoxymethyl]benzene, 3-ethyl-3-(phenoxymethyl)oxetane, di [(3-ethyl-3-oxetanyl)methyl]ether, 3-ethyl-3-(2-ethylhexyloxymethyl)oxetane, and phenol novolac oxetane. Examples of commercially available products thereof include ARON OXETANE OXT-101, ARON OXETANE OXT-121, ARON OXETANE OXT-211, ARON OXETANE OXT-221, and ARON OXETANE OXT-212 (all manufactured by Toagosei Co., Ltd.). In the invention, the cationically polymerizable curable resin composition preferably contains a vinyl ether group-containing compound, which is effective in improving the curing properties of the composition or reducing the liquid viscosity of the composition. Examples of such a vinyl ether group-containing compound include 2-hydroxyethyl vinyl ether, diethylene glycol monovinyl ether, 4-hydroxybutyl vinyl ether, diethylene glycol monovinyl ether, triethylene glycol divinyl ether, cyclohexanedimethanol divinyl ether, cyclohexanedimethanol monovinyl ether, tricyclodecane vinyl ether, cyclohexyl vinyl ether, methoxyethyl vinyl ether, ethoxyethyl vinyl ether, and pentaerythritol tetravinyl ether.

<Photo-Cationic Polymerization Initiator>

When the cationically polymerizable curable resin composition contains, as a curable component, at least one compound selected from the epoxy group-containing compound, the oxetanyl group-containing compound, and the vinyl ether group-containing compound described above, a photo-cationic polymerization initiator should be added to the composition because these compounds are all curable by cationic polymerization. When irradiated with active energy rays such as visible rays, ultraviolet rays. X-rays, or electron beams, the photo-cationic polymerization initiator generates a cationic species or a Lewis acid to initiate the polymerization reaction of the epoxy group or the oxetanyl group. The photo-acid generator described below is preferably used as the photo-cationic polymerization initiator. When the curable resin composition used in the invention is visible ray-curable, it is preferable to use a photo-cationic polymerization initiator with high sensitivity particularly to light of 380 nm or more. Unfortunately, a common photo-cationic polymerization initiator is a compound having maximum absorption in a wavelength region near or below 300 nm. Therefore, a photosensitizer having maximum absorption of light at a wavelength longer than such a wavelength region, specifically, longer than 380 nm should be added to the composition, so that it can accelerate the generation of a cationic species or an acid from the photo-cationic polymerization initiator by responding to light at a wavelength around that wavelength. Examples of the photosensitizer include anthracene compounds, pyrene compounds, carbonyl compounds, organosulfur compounds, persulfides, redox compounds, azo and diazo compounds, halogen compounds, and photo-reducing pigments. A mixture of two or more of these compounds may also be used. Anthracene compounds are particularly preferred because of their high photosensitizing effect. Specific examples of such compounds include ANTHRACURE UVS-1331 and ANTHRACURE UVS-1221 (manufactured by Kawasaki Kasei chemicals Ltd.). The content of the photosensitizer is preferably from 0.1% by weight to 5% by weight, more preferably from 0.5% by weight to 3% by weight.

<Other Components>

The curable resin composition used in the invention preferably contains the components described below.

<Acrylic Oligomer>

The active energy ray-curable resin composition used in the invention may contain an acrylic oligomer, which is formed by polymerization of a (meth)acrylic monomer, in addition to the radically polymerizable compound as a curable component. The acrylic oligomer in the active energy ray-curable resin composition can reduce curing shrinkage in the process of irradiating and curing the composition with active energy rays and can also reduce the interface stress between the adhesive and the adherends such as the polarizer and the transparent protective film. This makes it possible to suppress the reduction in the adhesion between the adhesive layer and the adherend. The content of the acrylic oligomer is preferably 20% by weight or less, more preferably 15% by weight or less, based on the total amount of the curable resin composition in order to sufficiently suppress the curing shrinkage of the curing product layer (adhesive layer). If the content of the acrylic oligomer in the curable resin composition is too high, a sharp reduction in reaction rate may occur to cause insufficient curing when the composition is irradiated with active energy rays. On the other hand, the content of the acrylic oligomer is preferably 3% by weight or more, more preferably 5% by weight or more, based on the total amount of the curable resin composition.

In view of workability or uniformity during coating, the active energy ray-curable resin composition preferably has low viscosity. Therefore, the acrylic oligomer formed by polymerization of a (meth)acrylic monomer also preferably has low viscosity. The acrylic oligomer that has low viscosity and can prevent curing shrinkage of the adhesive layer preferably has a weight average molecular weight (Mw) of 15,000 or less, more preferably 10,000 or less, even more preferably 5,000 or less. On the other hand, to suppress curing shrinkage of the curing product layer (adhesive layer), the acrylic oligomer preferably has a weight average molecular weight (Mw) of 500 or more, more preferably 1,000 or more, even more preferably 1,500 or more. Examples of the (meth)acrylic monomer that may be used to form the acrylic oligomer include (C1 to C20) alkyl (meth)acrylates such as methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, sec-butyl (meth)acrylate, tert-butyl (moth)acrylate, n-pentyl (meth)acrylate, tert-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, and n-octadecyl (meth)acrylate; cycloalkyl (meth)acrylates (e.g., cyclohexyl (meth)acrylate and cyclopentyl (meth)acrylate); aralkyl (meth)acrylates (e.g., benzyl (meth)acrylate); polycyclic (moth)acrylates (e.g., 2-isobornyl (meth)acrylate, 2-norbornylmethyl (meth)acrylate, 5-norbornen-2-yl-methyl (meth)acrylate, and 3-methyl-2-norbornylmethyl (meth)acrylate); hydroxyl group-containing (meth)acrylates (e.g., hydroxyethyl (meth)acrylate, 2-hydroxypropyl (meth)acrylate, and 2,3-dihydroxypropylmethyl-butyl (meth)acrylate); alkoxy group- or phenoxy group-containing (meth)acrylates (e.g., 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, and phenoxyethyl (meth)acrylate); epoxy group-containing (meth)acrylates (e.g., glycidyl (meth)acrylate); halogen-containing (meth)acrylates (e.g., 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, and heptadecafluorodecyl (meth)acrylate); and alkylaminoalkyl (meth)acrylates (e.g., dimethylaminoethyl (meth)acrylate). These (math)acrylates may be used singly or in combination of two or more. Examples of the acrylic oligomer include ARUFON manufactured by Toagosei Co., Ltd., Act flow manufactured by Soken Chemical & Engineering Co., Ltd., and JONCRYL manufactured by BASF Japan Ltd.

<Photo-Acid Generator>

The active energy ray-curable resin composition may contain a photo-acid generator. The use of the active energy ray-curable resin composition containing a photo-acid generator makes it possible to form an adhesive layer with a dramatically higher level of water resistance and durability than the use of the active energy ray-curable resin composition containing no photo-acid generator. The photo-acid generator may be represented by formula (5) below.

Formula (5)

L⁺ X⁻ (Formula 12)

wherein L* represents any onium cation, and X represents a counter anion selected from the group consisting of PF₆⁻, SbF₆⁻, AsF₆⁻, SbCl₆⁻, BiCl₅⁻, SnCl₆⁻, ClO₄⁻, dithiocarbamate anion, and SCN⁻.

Next, the counter anion X⁻ in formula (5) will be described.

Although not limited in principle, the counter anion X⁻ in formula (5) is preferably a non-nucleophilic anion. When the counter anion X⁻ is a non-nucleophilic anion, nucleophilic reaction is less likely to occur with the coexisting cation in the molecule or with various materials used in combination with the anion, so that the photo-acid generator represented by formula (4) itself and the composition containing it can have improved stability over time. As used herein, the terra “non-nucleophilic anion” refers to an anion less capable of undergoing nucleophilic reaction. Examples of such an anion include PF₆⁻, SbF₆⁻, AsF₆⁻, SbCl₆⁻, BiCl₅⁻, SnCl₄⁻, ClO₄⁻, dithiocarbamate anion, and SCN⁻.

Specifically, preferred examples of the photo-acid generator in the invention include CYRACURE UVI-6992 and CYRACURE UVI-6974 (all manufactured by Dow Chemical Japan Limited), ADEKA OPTOMER SP150, ADEKA OPTOMER SP152, ADEKA OPTOMER SP170, and ADEKA OPTOMER SP172 (all manufactured by ADEKA CORPORATION), IRGACURE 250 (manufactured by Ciba Specialty Chemicals Inc.), CI-5102 and CI-2855 (all manufactured by Nippon Soda Co., Ltd.), SAN-AID SI-60L, SAN-AID SI-80L, SAN-AID SI-100L, SAN-AID SI-110L, and SAN-AID SI-180L (all manufactured by SANSHIN CHEMICAL INDUSTRY CO., LTD.), CPI-100P and CPI-100A (all manufactured by SAN-APRO LTD.), and WPI-069, WPI-113, WPI-116, WPI-041, WPI-044, WPI-054, WPI-055, WPAG-281, WPAG-567, and WPAG-596 (all manufactured by Wako Pure Chemical Industries, Ltd.).

The content of the photo-acid generator is preferably from 0.01 to 10% by weight, more preferably from 0.05 to 5% by weight, even more preferably from 0.1 to 3% by weight, based on the total amount of the curable resin composition.

<Compound Containing Either Alkoxy Group or Epoxy Group>

The active energy-ray curable resin composition may contain the photo-acid generator together with a compound containing either an alkoxy group or an epoxy group.

(Epoxy Group-Containing Compound and Polymer)

A compound having one or more epoxy groups per molecule or a polymer (epoxy resin) having two or more epoxy groups per molecule may be used. In this case, a compound having two or more functional groups per molecule reactive with an epoxy group may be used in combination with the epoxy group-containing compound or polymer. The functional group reactive with an epoxy group may be, for example, carboxyl, phenolic hydroxyl, mercapto, or primary or secondary aromatic amino. In particular, the compound preferably has two or more functional groups of any of these types per molecule in view of three-dimensionally curing properties.

Examples of polymers having one or more epoxy groups per molecule include epoxy resins such as bisphenol A epoxy resins derived from bisphenol A and epichlorohydrin, bisphenol F epoxy resins derived from bisphenol F and epichlorohydrin, bisphenol S epoxy resins, phenol novolac epoxy resins, cresol novolac epoxy resins, bisphenol A novolac epoxy resins, bisphenol F novolac epoxy resins, alicyclic epoxy resins, diphenyl ether epoxy resins, hydroquinone epoxy resins, naphthalene epoxy resins, biphenyl epoxy resins, fluorene epoxy resins. polyfunctional epoxy resins such as tri functional epoxy resins and tetra functional epoxy resins, glycidyl ester epoxy resins, glycidyl amine epoxy resins, hydantoin epoxy resins, isocyanurate epoxy resins, and aliphatic chain epoxy resins. These epoxy resins may be halogenated or hydrogenated. Examples of commercially available epoxy resin products include, but are not limited to, JER Coat 828, 1001, 801N, 806, 807, 152, 604, 630, 871, YX8000, YX8034, and YX4000 manufactured by Japan Epoxy Resins CO. , Ltd., EPICLON 830, EPICLON EXA-835LV, EPICLON HP-4032D, and EPICLON HP-820 manufactured by DIC Corporation, EP4100 series, EP4000 series, and EPU series manufactured by ADEKA CORPORATION, CELLOXIDE series (e.g., 2021, 2021P. 2083, 2085, and 3000), EPOLEAD series, and EHPE series manufactured by DAICEL CORPORATION, YD series, YDP series, YDCN series, YDB series, and phenoxy resins (polyhydroxypolyethers synthesized from bisphenols and epichlorohydrin and terminated at both ends with epoxy groups, e.g, YP series) manufactured by NIPPON STEEL & SUMIKIN CHEMICAL CO., LTD., DENACOL series manufactured by Nagase Chemtex Corporation, and Epolite series manufactured by Kyoeisha Chemical Co., Ltd. These epoxy resins may be used in combination of two or more.

(Alkoxyl Group-Containing Compound and Polymer)

The compound having an alkoxyl group in the molecule may be any known compound having at least one alkoxyl group per molecule. Such a compound is typically a melamine compound, an amino resin, or a silane coupling agent.

The content of the compound having either an alkoxy group or an epoxy group is generally 30% by weight or less based on the total amount of the curable resin composition. If the content of the compound in the composition is too high, the composition may provide reduced adhesion or degraded impact resistance to drop testing. The content of the compound in the composition is preferably 20% by weight or less. On the other hand, in view of water resistance, the content of the compound in the composition is preferably 2% by weight or more, more preferably 5% by weight or more.

<Silane Coupling Agent>

When the curable resin composition used in the invention is active energy ray-curable, a silane coupling agent may be used, which is preferably an active energy ray-curable compound. However, even when not active energy ray-curable, a silane coupling agent can also impart a similar level of water resistance.

Examples of silane coupling agents as active energy ray-curable compounds include vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-gIycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

Preferred are 3-methacryloxypropyltrimethoxysilane and 3-acryloxypropyltrimethoxysilane.

Examples of non-active-energy-ray-curable silane coupling agents are preferably amino group-containing silane coupling agents. Examples of amino group-containing silane coupling agents include amino group-containing si lanes such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilane, (2-aminoethyl)aminomethyltrimethoxysilane, and N,N′-bis [3-(trimethoxysilyl)propyl]ethylenediamine; and ketimine silanes such as N-(1,3-dimethylbutylidene)-3-(triethoxysilyl)-1-propaneamine.

These amino group-containing silane coupling agents may be used singly or in combination of two or more. Among them, γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propaneamine are preferred in order to ensure good adhesion.

The content of the silane coupling agent is preferably in the range of 0.01 to 20% by weight, more preferably 0.05 to 15% by weight, even more preferably 0.1 to 10% by weight, based on the total amount of the curable resin composition. If the content is more than 20% by weight, the curable resin composition may have degraded storage stability, and if the content is less than 0.1% by weight, the water-resistant adhesion effect may fail to be sufficiently produced.

Examples of non-active-energy-ray-curable silane coupling agents other than the above include 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazolesilane.

<Vinyl Ether Group-Containing Compound>

The curable resin composition used in the invention preferably contains a vinyl ether group-containing compound, so that the resulting adhesive layer can have improved water-resistant adhesion to the polarizer. Although it is not clear why this effect can be obtained, one reason may be that the vinyl ether group of the compound can interact with the polarizer so that, the resulting adhesive layer can have an increased adhering strength to the polarizer. In order to make more water-resistant the adhesion between the polarizer and the adhesive layer, the compound should preferably be a vinyl ether group-containing, radically polymerizable compound. The content of the compound is preferably from 0.1 to 19% by weight based on the total amount of the curable resin composition.

<Organometallic Compound>

The curable resin composition used in the invention may contain an organometallic compound. The organometallic compound contained in the curable resin composition can further enhance the effect of the invention, specifically, can further enhance the water resistance of the polarizing film under harsh conditions.

The organometallic compound is preferably at least one selected from the group consisting of a metal alkoxide and a metal chelate. The metal alkoxide may be a compound having at least one alkoxy group, as an organic group, bonded to metal. The metal chelate may be a compound having an organic group bonded or coordinated to metal with an oxygen atom between them. The metal is preferably titanium, aluminum, or zirconium. In particular, aluminum and zirconium are more rapidly reactive than titanium and may shorten the pot life of the adhesive composition and reduce the effect of improving water-resistant adhesion. Therefore, the metal for the organometallic compound is more preferably titanium for the improvement of the water-resistant adhesion of the adhesive layer.

When the curable resin composition according to the invention contains a metal alkoxide as the organometallic compound, the metal alkoxide preferably has an organic group of four or more carbon atoms, more preferably six or more carbon atoms. If the organic group has three or less carbon atoms, the curable resin composition may have a shorten pot life, and the water-resistant adhesion may be less effectively improved. The organic group of six or more carbon atoms may be, for example, an octoxy group, which is preferably used. Preferred examples of the metal alkoxide include tetraisopropyl titanate, tatra-n-butyl titanate, butyl titanate dimer, tetraoctyl titanate, tert-amyl titanate, tetra-tert-butyl titanate, tetrastearyl titanate, zirconium tetraisopropoxide, zirconium tetra-n-butoxide. zirconium tetraoctoxide, zirconium tetra-tert-butoxide, zirconium tetrapropoxide, aluminum sec-butylate, aluminum ethylate, aluminum isopropylate, aluminum butylate, aluminum diisopropylate mono-sec-butylate, and mono-sec-butoxy aluminum diisopropylate. In particular, tetraoctyl titanate is preferred.

When the curable resin composition according to the invention contains a metal chelate as the organometallic compound, the metal chelate preferably has an organic group of four or more carbon atoms. If the organic group has three or less carbon atoms, the curable resin composition may have a shorten pot life, and the water-resistant adhesion may be less effectively improved. The organic group of four or more carbon atoms may be, for example, an acetylacetonate group, an ethylacetoacetate group, an isostearate group, or an octyleneglycolate group. Among them, the organic group is preferably an acetylacetonate group or an ethylacetoacetate group in view of the water-resistant adhesion of the adhesive layer. Preferred examples of the metal chelate include titanium acetylacetonate, titanium octyleneglycolate, titanium tetraacetylacetonate, titanium ethylacetoacetate, polyhydroxytitanium strearate, dipropoxy-bis(acetylacetonato)titanium, dibutoxytitanium-bis(octyleneglycolate), dipropoxytitanium-bis(ethylacetoacetate), titanium lactate, titanium diethanolaminate, titanium triethanolaminate, dipropoxytitanium-bis(lactate), dipropoxytitanium-bis(triethanolaminate), di-n-butoxytitanium-bis(triethanolaminate), tri-n-butoxytitanium monostearate, diisopropoxybis(ethylacetoacetate)titanium, dilsopropoxybis(acetylacetate)titanium, diisopropoxybis(acetylacetone)titanium, phosphate-titanium compounds, titanium lactate ammonium salt, titanium-1,3-propanedioxybis(ethylacetoacetate), dodecylbenzenesulfonate-titanium compounds, titanium aminoethylaminoethanolate, zirconium tetraacetylacetonate, zirconium monoacetylacetonate, zirconium bisacetylacetonate, zirconium acetylacetonate bisethylacetoacetate, zirconium acetate, tri-n-butoxyethylacetoacetate zirconium, di-n-butoxybis(ethylacetoacetate)zirconium, n-butoxytris(ethylacetoacetate)zirconium, tetrakis (n-propylacetoacetate)zirconium, tetrakis(acetylacetoacetate)zirconium, tetrakis(ethylacetoacetate)zirconium, aluminum ethylacetoacetate, aluminum acetylacetonate, aluminum acetylacetonate bisethylacetoacetate, diisopropoxyethylacetoacetate aluminum, diisopropoxyacetylacetonate aluminum, isopropoxybis(ethylacetoacetate)aluminum, isopropoxybis(acetylacetonate)aluminum, tris(ethylacetoacetate)aluminum, tris(acetylacetonate)aluminum, and aluminum monoacetylacetonate bis(ethylacetoacetate). In particular, titanium acetylacetonato and titanium ethylacetoacetate are preferred.

Besides the above, examples of the organometallic compound that may be used in the invention include metal salts of organic carboxylic acids, such as zinc octoate, zinc laurate, zinc stearate, and tin octoate; and zinc chelate compounds such as zinc acetylacetone chelate, zinc benzoylacetone chelate, zinc dibenzoylmethane chelate, and zinc ethyl acetoacetate chelate.

In the invention, the content of the organometallic compound is preferably in the range of 0.05 to 9 parts by weight, more preferably in the range of 0.1 to 8 parts by weight, even more preferably in the range of 0.15 to 5 parts by weight, based on 100 parts by weight of the total amount of the active energy ray-curable components. If the content of the organometallic compound is more than 9 parts by weight, the adhesive composition may have degraded storage stability, or the content of the components for bonding to the polarizer or protective films may be relatively insufficient, which may lead to reduced adhesion. If the content of the organometallic compound is less than 0.05 parts by weight, the water-resistant adhesion effect may be insufficiently produced.

<Compound Capable of Undergoing Keto-Enol Tautomerism>

The curable resin composition used in the invention nay contain a compound capable of undergoing keto-enol tautomerism. In a preferred mode, for example, the compound capable of undergoing keto-enol tautomerism may be added to; the curable resin composition containing a crosslinking agent or to the curable resin composition to be used together with a crosslinking agent. This makes it possible to suppress, after the addition of the organometallic compound, an excessive increase in the viscosity of the curable resin composition, gelation of the curable resin composition, and production of a microgel, so that the pot-life of the composition can be effectively extended.

Any of various β-dicarbonyl compounds may be used as the compound capable of undergoing keto-enol tautoroerism. Examples include β-diketones such as acetyl acetone, 2,4-hexanedione, 3,5-heptanedione, 2-methylhexan-3,5-dione, 6-methylheptan-2,4-dione, and 2,6-dimethylheptan-3,5-dione; acetoacetic esters such as methyl acetoacetate, ethyl acetoacetate, isopropyl acetoacetate, and tert-butyl acetoacetate; propionyl acetate esters such as ethyl propionyl acetate, propionyl ethyl acetate, isopropyl propionyl acetate, and tert-butyl propionyl acetate; isobutyryl acetate esters such as ethyl isobutyryl acetate, isobutyryl ethyl acetate, isopropyl isobutyryl acetate, and tert-butyl isobutyryl acetate; and malonic esters such as methyl malonate and ethyl malohate. Particularly preferred compounds include acetyl acetone and acetoacetic esters. These compounds capable of undergoing keto-enol tautomerism may be used singly or in combination of two or more.

The compound capable of undergoing keto-enol tautomerism may be used in an amount of, for example, 0.05 to 10 parts by weight, preferably 0.2 to 3 parts by weight (e.g., from 0.3 to 2 parts by weight) based on 1 part by weight of the organometallic compound. If the compound is used in an amount of less than 0.05 parts by weight based on 1 part by weight of the organometallic compound, it may be difficult to sufficiently produce the effect of the use of the compound. On the other hand, if the compound is used in an amount of more than 10 parts by weight based on 1 part by weight of the organometallic compound, it may excessively interact with the organometallic compound to make it difficult to produce the desired water resistance.

<Additives other than the Above>

The curable resin composition used in the invention may also contain any of various additives as other optional components as long as the objects and effects of the invention are not impaired. Examples of such additives include polymers or oligomers such as epoxy resin, polyamide, polyamide imide, polyurethane, polybutadiene, polycloroprene, polyether, polyester, styrene-butadiene block copolymers, petroleum resin, xylene resin, ketone resin, cellulose resin, fluorooligomers, silicone oligomers, and polysulfide oligomers, polymerization inhibitors such as phenothiazine and 2,6-di-tert-butyl-4-methylphenol, polymerization initiation aids, leveling agents, wettability modifiers, surfactants, plasticizers, ultraviolet absorbers, inorganic fillers, pigments, and dyes.

The content of these additives is generally 0 to 10% by weight, preferably 0 to 5% by weight, most preferably 0 to 3% by weight, based on the total amount of the curable resin composition.

In view of safety, less skin irritant materials are preferably used as the curable components for the curable resin composition used in the invention. The skin irritation can be evaluated with an index called primary irritation index (P.I.I.). P.I.I., which is measured by Draize method, is widely used to indicate the degree of skin disorders. The measured values are indicated on a scale of 0 to 8, and a lower value indicates lower irritant properties. P.I.I, values should be taken as reference values because of relatively large measurement errors. The P.I.I. of the components is preferably 4 or less, more preferably 3 or less, most preferably 2 or less.

<Polarizing Film>

The polarizing film of the invention includes a polarizer and a cured resin layer formed on at least one surface of the polarizer by curing the curable resin composition. In particular, the cured resin layer is preferably an adhesive layer, and the polarizing film preferably has a transparent protective film provided on at least one surface of the polarizer with the adhesive layer interposed therebetween. Hereinafter, a polarizing film including a polarizer and a transparent protective film provided on at least one surface of the polarizer with the adhesive layer interposed therebetween will be described by way of example.

<Cured Resin Layer>

The cured resin layer, specifically the adhesive layer, made from the curable resin composition preferably has a thickness of 0.01 to 3.0 μm. If the cured resin layer is too thin, it may have insufficient cohesive strength and reduced peel strength, which are not preferred. If the cured resin layer is too thick, it may easily peel off when stress is applied to the cross-section of the polarizing film, so that impact-induced peeling defect may occur, which is not preferred. The thickness of the adhesive layer is more preferably from 0.1 to 2.5 μm, most preferably from 0.5 to 1.5 μm.

The curable resin composition is preferably selected so that it can form a cured resin layer, specifically an adhesive layer, with a glass transition temperature (Tg) of 60° C. or more, more preferably 70° C. or more, even more preferably 75° C. or more, further more preferably 100° C. or more, still more preferably 120° C. or more. On the other hand, if the adhesive layer has too high a Tg, it can reduce the flexibility of the polarizing film. Therefore, the adhesive layer preferably has a Tg of 300° C. or less, more preferably 240° C. or less, even more preferably 180° C. or less. The glass transition temperature (Tg) can be measured with a dynamic viscoelastometer RSA-III manufactured by TA Instruments under the following conditions: sample size, 10 mm wide, 30 mm long; clamp distance, 20 mm; measurement mode, tensile mode; frequency, 1 Hz; rate of temperature rise, 5° C./minute. The dynamic viscoelasticity is measured, and the tan δ peak temperature is used as the Tg.

The curable resin composition is also preferably such that it can form a cured resin layer, specifically an adhesive layer, with a storage modulus of 1.0×10⁷ Pa or more, more preferably 1.0×10⁸ Pa or more, at 25° C. Pressure-sensitive adhesive layers have a storage modulus of 1.0×10³ Pa to 1.0×10⁶ Pa, which differs from that of the adhesive layer. The storage modulus of the adhesive layer has an influence on the cracking of the polarizer under heat cycles (e.g., from −40° C. to 80° C.) applied to the polarizing film. If the storage modulus is low, cracking defect may easily occur in the polarizer. The temperature range where the adhesive layer can have high storage modulus is more preferably 80° C. or less, most preferably 90° C. or less. The storage modulus can be measured together with the glass transition temperature (Tg) using a dynamic viscoelastometer RSA-III manufactured by TA instruments under the same conditions. The dynamic viscoelasticity is measured, and the resulting storage modulus (E′) is used.

The polarizing film according to the invention can be preferably manufactured by a method including the steps of: applying the curable resin composition according to the invention to at least one surface of a polarizer; and curing the curable resin composition with active energy rays applied from the polarizer surface side or the curable resin composite on-coated surface side. In the bonding step of this manufacturing method, the polarizer preferably has a water content of 8 to 19%. in addition, the polarizing film including a polarizer, on adhesive layer, and a transparent protective film provided on at least one surface of the polarizer with the adhesive layer interposed therebetween can be manufactured by a method including the steps of: applying the curable resin composition to the surface of at least one of the polarizer and the transparent protective film; laminating the polarizer and the transparent protective film; and bonding the polarizer and the transparent protective film together with an adhesive layer formed therebetween by curing the curable resin composition with active energy rays applied from the polarizer surface side or the transparent protective film surface side.

The polarizer and the transparent protective film may be subjected to a surface modification treatment before they are coated with the curable resin composition. In particular, the surface of the polarizer is preferably subjected to a surface modification treatment before it is coated with the curable resin composition or subjected to lamination. The surface modification treatment may be, for example, a corona treatment, a plasma treatment, or an ITRO treatment, and in particular, preferably a corona treatment. The corona treatment can produce polar functional groups such as carbonyl and amino groups on the surface of the polarizer, which can improve the adhesion to the cured resin layer. In addition, an ashing effect can be produced to remove foreign particles from the surface and to reduce irregularities on the surface, which makes it possible to produce a polarizing film with good appearance properties.

The method of applying the curable resin composition may be appropriately selected, depending on the viscosity of the curable resin composition and the desired thickness, from, for example, methods using a reverse coater, a gravure coater (direct, reverse, or offset), a bar reverse coater, a roll coater, a die coater, a bar coater, or a red coater. The curable resin composition used in the invention preferably has a viscosity of 3 to 100 mPa·s, more preferably 5 to 50 mPa·s, most preferably 10 to 30 mPa·s. Too high a viscosity of the curable resin composition may cause low surface smoothness or poor appearance after the application, and thus is not preferred. When applied, the curable resin composition used in the invention may be heated or cooled to have an adjusted viscosity in a desired range.

The polarizer and the transparent protective film are laminated with the curable resin composition applied as described above and interposed therebetween. The polarizer and the transparent protective film may be laminated using a roll laminator or other means.

<Curing of Curable Resin Composition>

In the invention, the curable resin composition is preferably used in the form of an active energy ray-curable resin composition. The active energy ray-curable resin composition may be used in the form of an electron beam-curable, ultraviolet ray-curable, or visible ray-curable composition. In view of productivity, the curable resin composition is preferably in the form of a visible ray-curable resin composition.

<<Active Energy Ray-Curable Composition>>

After the lamination of the polarizer and the transparent protective film, the active energy ray-curable resin composition is cured by applying active energy rays (such as electron beams, ultraviolet rays, or visible rays) to the composition, so that an adhesive layer is formed. The active energy rays (such as electron beams, ultraviolet rays, or visible rays) may be applied from any appropriate direction. Preferably, the active energy rays are applied from the transparent protective film side. If applied from the polarizer side, the active energy rays (such as electron beams, ultraviolet rays, or visible rays) may degrade the polarizer.

<<Electron Beam-Curable Composition>>

Electron beams may be applied under any appropriate conditions where the active energy ray-curable resin composition as an electron beam-curable composition can be cured. For example, electron beams are preferably applied at an acceleration voltage of 5 kV to 300 kV, more preferably 10 kV to 250 kV. If the acceleration voltage is lower than 5 kV, electron beams may fail to reach the adhesive, so that insufficient curing may occur. If the acceleration voltage is higher than 300 kV, electron beams can have too high intensity penetrating through the material and thus may damage the transparent protective film or the polarizer. The exposure dose is preferably from 5 to 100 kGy, more preferably from 10 to 75 kGy. At an exposure dose of less than 5 kGy, the adhesive may be insufficiently cured. An exposure dose of more than 100 kGy may damage the transparent protective film or the polarizer and cause yellow discoloration or a reduction in mechanical strength, which may make it impossible to obtain the desired optical properties.

Electron beam irradiation is generally performed in an inert gas. If necessary, however, electron beam irradiation may be performed in the air or under conditions where a small amount of oxygen is introduced. When oxygen is appropriately introduced, oxygen-induced inhibition can be intentionally produced on the surface of the transparent protective film, to which electron beams are first applied, so that the transparent protective film can be prevented from being damaged and electron beams can be efficiently applied only to the adhesive, although it depends on the material of the transparent protective film.

<<Ultraviolet-Curable Composition and Visible Ray-Curable Composition>>

The method according to the invention of manufacturing a polarizing film preferably uses active energy rays including visible rays with a wavelength in the range of 380 nm to 450 nm, specifically, visible rays whose dose is the highest at a wavelength in the range of 380 nm to 450 nm. When the transparent protective film used with respect to the ultraviolet ray- or visible ray-curable composition has the ability to absorb ultraviolet rays (the ultraviolet non-transmitting transparent protective film), it can absorb light with wavelengths shorter than about 380 nm. This means that light with wavelengths shorter than 380 nm cannot reach the active energy ray-curable resin composition and thus cannot contribute to the polymerization reaction of the composition. When absorbed by the transparent protective film, the light with wavelengths shorter than 380 run is also converted into heat, so that the transparent protective film itself can generate heat, which can cause a defect such as curling or wrinkling of the polarizing film. In the invention, therefore, when the ultraviolet ray- or visible ray-curable composition is used, the active energy ray generator used preferably does not emit light with wavelengths shorter than 380 nm. More specifically, the ratio of the total illuminance in the wavelength range of 380 to 440 nm to the total illuminance in the wavelength range of 250 to 370 nm is preferably from 100:0 to 100:50, more preferably from 100:0 to 100:40. In the invention, the source of active energy rays is preferably a gallium-containing metal halide lamp or an LED light source capable of emitting light with a wavelength in the range of 380 to 440 nm. Alternatively, a source of light containing ultraviolet and visible wavelengths, such as a low-pressure mercury lamp, a middle-pressure mercury lamp, a high-pressure mercury lamp, an ultrahigh-pressure mercury lamp, an incandescent lamp, a xenon lamp, a halogen lamp, a carbon arc lamp, a metal halide lamp, a fluorescent lamp, a tungsten lamp, a gallium lamp, an excimer laser, or sunlight may be used in combination with a band pass filter for blocking ultraviolet light with wavelengths shorter than 380 nm. For the purpose of preventing the polarizing film from curling while increasing the adhesion performance of the adhesive layer between the polarizer and the transparent protective film, it is preferable to use active energy rays obtained from a gallium-containing metal halide lamp through a band pass filter capable of blocking light with wavelengths shorter than 380 nm or to use active energy rays with a wavelength of 405 nm obtained with an LED light source.

When the active energy ray-curable resin composition is ultraviolet ray- or visible ray-curable, the active energy ray-curable resin composition is preferably heated before irradiated with ultraviolet or visible rays (heating before irradiation). In this case, the composition is preferably heated to 4° C. or higher, more preferably 50° C. or higher. The active energy ray-curable resin composition is also preferably heated after irradiated with ultraviolet or visible rays (heating after irradiation). In this case, the composition is preferably heated to 40° C. or higher, more preferably 50° C. or higher.

The active energy ray-curable resin composition according to the invention is particularly suitable for use in forming an adhesive layer to bond the polarizer and a transparent protective film with a 365 nm wavelength light transmittance of less than 5%. When containing the photopolymerization initiator of formula (3) shown above, the active energy ray-curable resin composition according to the invention can form a cured adhesive layer by being irradiated with ultraviolet rays through a transparent protective film having the ability to absorb UV. In this case, the adhesive layer can be cured even in a polarizing film including a polarizer and transparent protective films placed on both sides of the polarizer and each having the ability to absorb UV. It will be understood, however, that the adhesive layer can be cured also in a polarizing film where the transparent protective films placed on the polarizer have no ability to absorb UV. As used herein, the term “transparent protective films having the ability to absorb UV” means transparent protective films with a 380 nm light transmittance-of less than 10%.

Methods for imparting the ability to absorb UV to the transparent protective film include a method of adding an ultraviolet absorber into the transparent protective film and a method of placing, on the surface of the transparent protective film, a surface treatment layer containing an ultraviolet absorber.

Examples of the ultraviolet absorber include conventionally known oxybenzophenone compounds, benzotriazole compounds, salicylate ester compounds, benzophenone compounds, cyanoacrylate compounds, nickel complex salt compounds, and triazine compounds.

After the polarizer and the transparent protective film are laminated together, the active energy ray-curable resin composition is cured by the application of active energy rays (such as electron beams, ultraviolet rays, or visible rays) to form an adhesive layer. Active energy rays (such as electron beams, ultraviolet rays, or visible rays) may be applied from any suitable direction. Preferably, active energy rays are applied to the composition from the transparent protective film side. If applied from the polarizer side, active energy rays (such as electron beams, ultraviolet rays, or visible rays) may degrade the polarizer.

When the polarizing film according to the invention is manufactured using a continuous line, the line speed is preferably from 1 to 500 m/minute, more preferably from 5 to 300 m/minute, even more preferably from 10 to 100 m/minute, depending on the time required to cure the curable resin composition. If the line speed is too low, the productivity may be low, or damage to the transparent protective film may be too much, which may make it impossible to produce a polarizing film capable of withstanding durability tests or other tests. If the line speed is too high, the curable resin composition may be insufficiently cured, so that the desired adhesion may fail to be obtained.

The polarizing film of the invention preferably includes a polarizer and a transparent protective film bonded together with an adhesive layer that is interposed therebetween and made of a layer of a curing product of the active energy ray-curable resin composition. Such a polarizing film may further include an adhesion-facilitating layer between the transparent protective film and the adhesive layer. For example, the adhesion-facilitating layer may be made of any of various resins having a polyester skeleton, a polyether skeleton, a polycarbonate skeleton, a polyurethane skeleton, a silicone skeleton, a polyamide skeleton, a polyimide skeleton, a polyvinyl alcohol skeleton, or other polymer skeletons. These polymer resins may be used singly or in combination of two or more. Other additives may also be added to form the adhesion-facilitating layer. More specifically, a tackifier, an ultraviolet absorber, an antioxidant, or a stabilizer such as a heat-resistant stabilizer may also be used to form the adhesion-facilitating layer.

Generally, the adhesion-facilitating layer is provided in advance on the transparent protective film, and then the adhesion-facilitating layer side of the transparent protective film is bonded to the polarizer with the adhesive layer. The adhesion-facilitating layer can be formed using a known technique that includes applying an adhesion-facilitating-layer-forming material onto the transparent protective film and drying the material. The adhesion-facilitating-layer-forming material is generally prepared in the form of a solution which is diluted to a suitable concentration taking into account the coating thickness after drying, the smoothness of the application, and other factors. After dried, the adhesion-facilitating layer preferably has a thickness of 0.01 to 5 μm, more preferably 0.02 to 2 μm, even more preferably 0.05 to 1 μm. Two or more adhesion-facilitating layers may be provided. Also in this case, the total thickness of the adhesion-facilitating layers preferably falls within such ranges.

<Polarizer>

Any of various polarizers may be used without limitation. The polarizer may be, for example, a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous. The thickness of the polarizer is preferably from 2 to 30 μm, more preferably from 4 to 20 μm, most preferably from 5 to 15 μm. An excessively thin polarizer can have reduced optical durability and thus is not preferred. An excessively thick polarizer can undergo significant dimensional changes under high-temperature, high-humidity conditions and cause the problem of display unevenness and thus is not preferred.

A polarizer including a uniaxially-stretched polyvinyl alcohol-based film dyed with iodine can be produced, for example, by a process including immersing a polyvinyl alcohol film in an aqueous iodine solution to dye the film and stretching the film to 3 to 7 times the original length. If necessary, the film may also be immersed in an aqueous solution of boric acid or potassium iodide, if necessary, the polyvinyl alcohol-based film may be further immersed in water for washing before it is dyed. When the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid or potassium iodide or in a water bath.

In the invention, the advantageous effects of the use of the active energy ray-curable resin composition (a satisfactory level of optical durability in a harsh environment at high temperature and high humidity) will be significantly produced when a thin polarizer with a thickness of 10 μm or less is used. Such a polarizer with a thickness of 10 μm or less is relatively more affected by water, has less sufficient optical durability in an environment at high temperature and high humidity, and is more likely to increase in transmittance or decrease in degree of polarization than polarizers with a thickness of more than 10 μm. In other words, when the adhesive layer according to the invention with a bulk water absorption rate of 10% by weight or less is formed on the polarizer with a thickness of 10 μm or less, the movement of water into the polarizer will be suppressed in a harsh environment at high temperature and high humidity, which makes it possible to significantly suppress degradation in the optical durability of the polarizing film, such as an increase in the transmittance of the polarizing film or a decrease in the degree of polarization of the polarizing film. For thickness reduction, the thickness of the polarizer is preferably from 1 to 7 μm. Such a thin polarizer is preferred because it is less uneven in thickness, provides good visibility, is less dimensionally variable, and can form a thin polarizing film.

Typical examples of such a thin polarizer include the thin polarizing films described in JP-A-51-069644, JP-A-2000-338329, WO2010/100917, PCT/JP2010/001460, Japanese Patent Application No. 2010-269002, and Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage by stretching, because the layer is supported on the stretchable resin substrate.

Among processes including the steps of stretching and dyeing a laminate, a process capable of achieving high-ratio stretching to improve polarizing performance is preferably used when the thin polarizing film is formed. Thus, the thin polarizing film is preferably obtained by a process including the step of stretching in an aqueous boric acid solution as described in WO2010/100917, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution, as described in Japanese Patent Application No. 2010-269002 or 2010-263692.

<Transparent Protective Film>

The transparent protective film is preferably made of a material having a high level of transparency, mechanical strength, thermal stability, water barrier properties, isotropy, and other properties. Examples of such a material include polyester polymers such as polyethylene terephthalate and polyethylene naphthalate, cellulose polymers such as diacetyl cellulose and triacetyl cellulose, acryl-based polymers such as polymethyl methacrylate, styrene polymers such as polystyrene and acrylonitrile-styrene copolymers (AS resins), and polycarbonate polymers. Examples of polymers that may be used to form the transparent protective film also include polyolefin polymers such as polyethylene, polypropylene, cyclo- or norbornene-structure-containing polyolefin, and ethylene-propylene copolymers, vinyl chloride polymers, amide polymers such as nylon and aromatic polyamide, imide polymers, sulfone polymers, polyether sulfone polymers, polyether ether ketone polymers, polyphenylene sulfide polymers, vinyl alcohol polymers, vinylidene chloride polymers, vinyl butyral polymers, arylate polymers, polyoxymethylene polymers, epoxy polymers, or any blends of the above polymers. The transparent protective film may also contain any one or more appropriate additives. Examples of such additives include ultraviolet absorbers, antioxidants, lubricants, plasticizers, release agents, discoloration preventing agents, flame retardants, nucleating agents, antistatic agents, pigments. and colorants. The content of the thermoplastic resin in the transparent protective film is preferably from 50 to 100% by weight, more preferably from 50 to 99% by weight, even more preferably from 60 to 98% by weight, further more preferably from 70 to 97% by weight. If the content of the thermoplastic resin in the transparent protective film is 50% by weight or less, high transparency and other properties inherent in the thermoplastic resin may fail to be sufficiently exhibited.

The transparent protective film may also be the polymer film described in JP-A-2001-343529 (WO01/37007), such as a film of a resin composition containing (A) a thermoplastic resin having a substituted and/or unsubstituted imide group in the side chain and a thermoplastic resin having a substituted and/or unsubstituted phenyl and nitrile groups in the side chain. A specific example includes a film of a resin composition containing an alternating copolymer of isobutylene and N-methylmaleimide and an acrylonitrile-styrene copolymer. Films such as those produced by mixing and extruding the resin composition may be used. These films have a small retardation and a small photoelastic coefficient and thus can prevent the polarizing film from having defects such as strain-induced unevenness. They also have low water-vapor permeability and thus have high moisture resistance.

In the polarizing film, the transparent protective film preferably has a water-vapor permeability of 150 g/m²/24 hours or less. This feature makes the polarizing film resistant to the entry of water from the air and also prevents the polarizing film from changing in water content. As a result, storage environment-induced curling or dimensional change of the polarizing film can be suppressed.

The transparent protective film or films provided on one or both sides of the polarizer should preferably have a high level of transparency, mechanical strength, thermal stability, water barrier properties, isotropy, and other properties. In particular, the transparent protective film or films preferably have a water-vapor permeability of 150 g/m²/24 hours or less, more preferably 140 g/m²/24 hours or less, even more preferably 120 g/m²/24 hours or less. The water-vapor permeability can be determined by the method described in the EXAMPLES section.

Examples of materials that may be used to form the transparent protective film with a satisfactorily low level of water-vapor permeability as mentioned above include polyester resins such as polyethylene terephthalate and polyethylene naphthalate, polycarbonate resins, arylate resins, amide resins such as nylon and aromatic polyamide, polyolefin polymers such as polyethylene, polypropylene, and ethylene-propylene copolymers, cyclic olefin-based resins having a cyclo-structure or a norbornene structure, (meth)acrylic resins, or any blends thereof. Among these resins, polycarbonate resins, cyclic polyolefin resins, and (meth)acrylic resins are preferred, and cyclic polyolefin resins and (meth)acrylic resins are particularly preferred.

The thickness of the transparent protective film may be selected as appropriate, in general, the transparent protective film preferably has a thickness of 5 to 100 μm in view of strength, workability such as handleability, thin layer formability, and other properties. In particular, the thickness of the transparent protective film is preferably from 10 to 60 μm, more preferably from 20 to 40 μm.

The polarizer and the protective film may be laminated by a method using a roll laminator. The method of forming a laminate of the polarizer and the protective films on both sides thereof may be selected from a method of attaching one protective film to the polarizer and then attaching another protective film to the polarizer and a method of simultaneously attaching two protective films to the polarizer. The former method, namely, the method of attaching one protective film to the polarizer and then attaching another protective film is preferably used because it can significantly reduce the occurrence of entrapped air bubbles during the attachment.

The method of curing the curable resin composition nay be appropriately selected in a manner depending on the curing mode of the curable resin composition. When the curable resin composition is thermosetting, it can be cured by a heat treatment. The heat treatment method may be any conventionally known method such as a hot air oven method or an IR oven method. When the curable resin composition is active energy ray-curable, it can be cured by application of active energy rays such as electron beams, ultraviolet rays, or visible rays. When the curable resin composition is both thermosetting and active energy ray-curable, any appropriate combination of the above methods may be used. The curable resin composition according to the invention is preferably active energy ray-curable. Advantageously, the use of the active energy ray-curable resin composition makes it possible not only to provide high productivity but also to suppress the thermal degradation of the optical properties of the polarizer. In addition, the curable resin composition of the invention is preferably substantially free of any volatile solvent. Advantageously, the composition substantially free of any volatile solvent does not need a heat treatment, which makes it possible not only to provide high productivity but also to suppress the thermal degradation of the optical properties of the polarizer.

<Optical Film>

For practical use, the polarizing film of the invention may be laminated with any other optical layer or layers to form an optical film. As a non-limiting example, such an optical layer or layers may be one or more reflectors, transflectors, retardation plates (including wavelength plates such as half or quarter wavelength plates), viewing angle compensation films, or other optical layers, which can be used to form liquid crystal display devices or other devices. Particularly preferred is a reflective or transflective polarizing film Including the polarizing film of the invention and a reflector or a transflector disposed thereon, an elliptically or circularly polarizing film including the polarizing film and a retardation place disposed thereon, a wide viewing angle polarizing film including the polarizing film and a viewing angle compensation film disposed thereon, or a polarizing film including the polarizing film and a brightness enhancement film disposed thereon.

The optical film including the polarizing film and the optical layer disposed thereon may be formed by a method of stacking them one by one in the process of manufacturing a liquid crystal display device or any other device. However, an optical film formed in advance by lamination is advantageous in that it can facilitate the process of manufacturing a liquid crystal display device or any other device, because it has stable quality and good assembling workability. In the lamination, any appropriate bonding means such as a pressure-sensitive adhesive layer may be used. When the polarizing film and any other optical film are bonded together, their optical axes may be each aligned at an appropriate angle, depending on the desired retardation properties or other desired properties.

A pressure-sensitive adhesive layer for bonding to any other member such as a liquid crystal cell may also be provided on the polarizing film or the optical film including a laminate having at least one layer of the polarizing film. As a non-limiting example, the pressure-sensitive adhesive for use in forming the pressure-sensitive adhesive layer may be appropriately selected from pressure-sensitive adhesives containing, as a base polymer, an acryl-based polymer, a silicone-based polymer, polyester, polyurethane, polyamide, polyether, a fluoropolymer, or a rubber polymer. In particular, a pressure-sensitive adhesive having a high level of optical transparency, weather resistance, and heat resistance and exhibiting an appropriate degree of wettability, cohesiveness, and adhesion is preferably used, such as an acrylic pressure-sensitive adhesive.

The pressure-sensitive adhesive layer may also be formed as a laminate of layers different in composition, type, or other features on one or both sides of the polarizing film or the optical film. When pressure-sensitive adhesive layers are provided on both front and back sides of the polarizing film or the optical film, they may be different in composition, type, thickness, or other features. The thickness of the pressure-sensitive adhesive layer may be selected depending on the intended use. adhering strength, or other factors, and is generally from 1 to 500 μm, preferably from 1 to 200 μm, more preferably from 1 to 100 μm.

The exposed surface of the pressure-sensitive adhesive layer may be temporarily covered with a separator for anti-pollution or other purposes until it is actually used. This can prevent contact with the pressure-sensitive adhesive layer during usual handling. According to conventional techniques, except for the above thickness conditions, a suitable separator may be used, such as a plastic film, a rubber sheet, a paper sheet, a cloth, a nonwoven fabric, a net, a foam sheet, a metal foil, any laminate thereof, or any other suitable thin material, which is optionally coated with any suitable release agent such as a silicone, long-chain alkyl, or fluoride release agent, or molybdenum sulfide.

<Image Display Device>

The polarizing film or optical film of the invention is preferably used to form liquid crystal display devices or other various devices. Liquid crystal display devices may be formed according to conventional techniques. Specifically, a liquid crystal display device may be typically formed by appropriately assembling a liquid crystal cell, polarizing films or optical films, and optional components such as a lighting system, and incorporating a driving circuit according to any conventional techniques, except that the polarizing films or optical films used are according to the invention. The liquid crystal cell to be used may also be of any type such as TN type, STN type, or π type.

Any desired liquid crystal display device may be formed, such as a liquid crystal display device including a liquid crystal cell and the polarizing or optical film or films placed on one or both sides of the liquid crystal cell or a liquid crystal display device further including a backlight or a reflector in a lighting system, in such a case, the polarizing or optical film or films according to the invention may be placed on one or both sides of the liquid crystal cell. When the polarizing or optical films are provided on both sides, they may be the same or different. The process of forming a liquid crystal display device may also include placing a suitable component such as a diffusion plate, an antiglare layer, an anti-reflection film, a protective plate, a prism array, a lens array sheet, a light diffusion plate, or a backlight in one or more layers at a suitable position or positions.

### EXAMPLES

Hereinafter, examples of the invention will be described. It will be understood that the examples are not intended to limit the embodiments of the Invention.

<Preparation of Polarizer>

A 45-μm-thick polyvinyl alcohol film with an average degree of polymerization of 2,400 and a degree of saponification of 99.9% by mole was immersed In warm water at 30° C. for 60 seconds so that the film was allowed to swell. The film was then immersed in an aqueous solution of 0.3% iodine/potassium iodide (0.5/8 in weight ratio) and dyed while stretched to 3.5 times. The film was then stretched to a total stretch ratio of 6 times in a boric acid aqueous solution at 65° C. After the stretching, the film was dried in an oven at 40° C. for 3 minutes to give a polyvinyl alcohol-based polarizer (18 μm thick).

<Protective Films>

Protective Film A

Resin pellets were prepared by mixing 100 parts by weight of the imidized MS resin described in Production Example 1 of JP-A-2010-284840 and 0.62 parts by weight of a triazine ultraviolet absorber (T-712 (tradename) manufactured by ADEKA CORPORATION) in a biaxial kneader at 220° C. The resulting pellets were dried at 100.5 kPa and 100° C. for 12 hours and then extruded into a film (160 μm thick) from the T-die of a uniaxial extruder at a die temperature of 270° C. The film was then stretched in the film-feed direction under an atmosphere at 150° C. (to a thickness of 80 μm). Subsequently, the film was coated with an adhesion facilitating agent containing an aqueous urethane resin and then stretched in a direction perpendicular to the film-feed direction under an atmosphere at 150° C. to form a 40-μm-thick transparent protective film A (water-vapor permeability 58 g/m²/24 h).

Protective Film B

The protective film B used was a 55-μm-thick cyclic polyolefin film (ZEONOR manufactured by Zeon Corporation, water-vapor permeability 11 g/m²/24 h) having undergone a corona treatment.

<Water-Vapor Permeability of Transparent Protective Film>

The water-vapor permeability was measured using the water-vapor permeability test (cup method) according to JIS Z 0208. A cut piece sample with a diameter of 60 mm was placed in a moisture-permeable cup where about 15 g of calcium chloride had been placed. The cup was placed and stored in a thermostatic chamber at a temperature of 40° C. and a humidity of 90% R.H. The weight of the calcium chloride was measured before and after the storage for 24 hours, and the increase in the weight of the calcium chloride was determined and used to calculate the water-vapor permeability (g/m²/24 h).

<Active Energy Rays>

The source of active energy rays used was a visible light irradiator (gallium-containing metal halide lamp) Light Hammer 10 manufactured by Fusion UV Systems Inc. (valve, V valve; peak illuminance, 1,600 mW/cm²; total dose, 1,000/mJ/cm²; wavelength, 380-440 nm). The illuminance of the visible light was measured with Sola-Check System manufactured by Solatell Ltd.

### Examples 1 and 2 and Comparative Examples 1 and 2

(Preparation of Curable Resin Compositions)

According to the formulation shown in Table 1, the respective components were mixed and stirred for 1 hour to form an active energy ray-curable resin composition for each of Examples 1 and 2 and Comparative Examples 1 and 2. In Table 1, “compound A” corresponds to the compound represented by formula (1), and “compound B” the compound represented by formula (2).

### Example 3 and Comparative Example 3

(Preparation of Curable Resin Compositions)

According to the formulation shown in Table 1, the respective components were mixed and stirred for 1 hour to form an active energy ray-curable resin composition for each of Example 3 and Comparative Example 3.

(Preparation of Polarizing Film)

Using an MCD coater (manufactured by FUJI KIKAI KOGYO Co., Ltd; cell shape, honeycomb; the number of gravure roll lines, 1,000/inch; rotational speed, 140% relative to line speed), each of the curable resin compositions of Examples 1 to 3 and Comparative Examples 1 to 3 was applied to the surface of the protective films A and B to be bonded, so that a 0.7-μm-thick coating was formed. The protective films A and B with the coating were laminated to both sides of the polarizer using a roller. Subsequently, the visible rays were applied to both sides to cure the active energy ray-curable resin composition. Each resulting laminate was then hot air-dried at 70° C. for 3 minutes to give a polarizing film including the polarizer and the transparent protective films on both sides of the polarizer. The lamination was performed at a line speed of 25 m/minute.

The polarizing films obtained in the examples and the comparative examples were evaluated as described below. Table 1 shows the evaluation results.

<Adhering Strength>

A piece was cut from the polarizing film obtained in each example. Each cut piece had a length of 200 mm parallel to the stretched direction of the polarizer and a width of 20 mm perpendicular thereto. After an incision was made between the transparent protective film and the polarizer with a cutter knife, each cut piece of polarizing film was bonded to a glass sheet. Using a Tensilon tester, the transparent protective film was peeled off at an angle of 90° and a peel rate of 10 m/minute from the polarizer when the peel strength was measured. The infrared absorption spectrum of the surface exposed after the peeling off was also measured by ATR method, and the interface exposed by the peeling off was evaluated based on the criteria below.

A: Cohesive failure of the transparent protective film

B: Interfacial peeling between the transparent protective film and the adhesive layer

C: Interfacial peeling between the adhesive layer and the polarizer

D: Cohesive failure of the polarizer

As for the criteria, A and D mean that the adhering strength is excellent because it is higher than the cohesive strength of the film. On the other hand, B and C mean that the adhering strength at the interface between the transparent protective film and the adhesive layer (and the adhering strength between the adhesive layer and the polarizer) is insufficient (or the adhering strength is poor). Taking these into account, the adhering strength evaluated as A or D is rated as O (good), the adhering strength evaluated as A/B (“cohesive failure of the transparent protective film” and “interfacial peeling between the transparent protective film and the adhesive layer” occur simultaneously) is rated as Δ (fair), the adhering strength evaluated as A/C (“cohesive failure of the transparent protective film” and “interfacial peeling between the adhesive layer and the polarizer” occur simultaneously) is rated as Δ (fair), and the adhering strength evaluated as B or C only is rated as x (poor).

<Hot Water Immersion Test>

A rectangular piece was cut from the polarizing film obtained in each example. Each cut piece had a length of 50 mm in the stretched direction of the polarizer and a width of 25 mm perpendicular thereto. Each cut piece of polarizing film was immersed in hot water at 60° for 6 hours and then measured for peeling length visually with a loupe. The peeling length was measured as the maximum vertical distance (mm) from the cross-section of the site where the peeling occurred. Cases where the peeling length is 5 mm or less were evaluated as being practically acceptable.

<Hot Water Immersion Peel Test>

A piece was cut from the polarizing film obtained in each example. Each cut piece had a length of 200 mm parallel to the stretched direction of the polarizer and a width of 20 mm perpendicular thereto. Each cut piece of polarizing film was immersed in hot water at 60° for 6 hours and then taken out and wiped with a dry cloth. Subsequently, after an incision was made between the transparent protective film and the polarizer with a cutter knife, each cut piece of polarizing film was bonded to a glass sheet. Each cut piece was evaluated within one minute after taken out of the pure water. Subsequently, each cut piece was evaluated as described in the <Adhering strength> section.

<Humidity Durability Test>

The polarizing film obtained in each example was exposed to an environment at 85° C. and 85% RH for 500 hours. Before and after the exposure, the polarization degree was determined using an integrating sphere-equipped spectrophotometer (V7100 manufactured by JASCO Corporation), from which the amount ΔP of change in the polarization degree was calculated using the formula: ΔP (%)=(the polarization degree (%) before the exposure)−(the polarization degree (%) after the exposure). The amount ΔP of change in the polarization degree is preferably less than 3.0%, more preferably 1.0% or less, even more preferably 0.5% or less. The polarization degree P is calculated from the formula below using the transmittance (parallel transmittance Tp) of a laminate of the same two polarizing films with their transmission axes parallel to each other and the transmittance (crossed transmittance Tc) of a laminate of the same two polarizing films with their transmission axes orthogonal to each other. Polarization degree P (%)={(Tp−Tc)/(Tp+Tc)}^{1/2}×100

TABLE 1

| | | | | | | Comparative | Comparative | Comparative |
|---|---|---|---|---|---|---|---|---|
| | | | Example 1 | Example 2 | Example 3 | Example 1 | Example 2 | Example 3 |
| Curable resin | Compound A | 1-Acrylamidophenylboronic | 3 | 1 | 1 | 0 | 0 | 0 |
| composition | | acid | | | | | | |
| | Compound B | Hydroxyethylacrylatide | 0 | 10 | 18 | 10 | 0 | 10 |
| | | Acrylaylmolphaline | 0 | 30 | 30 | 30 | 0 | 30 |
| | Curable resin | 1,9-Nonanediol diacrylate | 62 | 54 | 53 | 55 | 63 | 94 |
| | | Tricyclodecanedienthenol | 30 | 0 | 0 | 0 | 32 | 0 |
| | | diacrylate | | | | | | |
| | Polymerization | INGACURE 907 | 3 | 3 | 3 | 3 | 3 | 3 |
| | initiator | KAYACURE DRTX-S | 2 | 2 | 2 | 2 | 2 | 2 |
| | Other components | OK3ATIX TC109 | 0 | 0 | 1 | 1 | 0 | 1 |
| | | Phenylboronic acid | 0 | 0 | 0 | 0 | 0 | 1 |
| | Viscosity [mPa/s] | | 14 | 10 | 15 | 10 | 13 | 10 |
| Evaluations | Adhering strength | Peal strength | 4.58 | 4.5N | 4.5N | 4.4N | 0.2N | 4.5N |
| | [protective film A] | Interfacial pealing | ◯ (A) | ◯ (A) | ◯ (A) | ◯ (A) | X (H · C) | ◯ (A) |
| | Adhering strength | Peal strength | 3.7N | 4.0N | 4.1 | 3.5N | 0.2N | 3.0N |
| | [protective film B] | Interfacial pealing | ◯ (A) | ◯ (A) | ◯ (A) | ◯ (A) | X (H · C) | ◯ (A) |
| | Hot water immersion test | | ◯ (1 mm) | ◯ (1 mm) | ◯ (0.7 mm) | ◯ (1 mm) | X (25 mm) | ◯ (1 mm) |
| | Hot water immersion | Peal strength | 1.0N | 3.3N | 4.2N | 0.7N | 0.2N | 0.2N |
| | peal test | Interfacial pealing | ◯ (A) | ◯ (A) | ◯ (A) | X (C) | X (C) | X (C) |
| | [protective film A] | | | | | | | |
| | Hot water immersion | Peal strength | 3.3N | 3.4N | 4.0N | 4.2N | 0.2N | 0.2N |
| | peal test | Interfacial pealing | ◯ (A) | ◯ (A) | ◯ (A) | X (C) | X (C) | X (C) |
| | [protective film B] | | | | | | | |
| | Humidity durability | Change ΔP in polorization | 0.3% | 0.4% | 0.3% | 1.7% | 1.5% | 1.6% |
| | test | degree | | | | | | |

In Table 1, 3-acrylamidophenylboronic acid (manufactured by JUNSEI CHEMICAL CO., LTD.) corresponds to compound A;

hydroxyethylacrylamide (HEAA manufactured by KOHJIN Film & Chemicals Co., Ltd.) and acryloylmorpholine (ACMO manufactured by KOHJIN Film & Chemicals Co., Ltd.) correspond to compound B,

ORGATIX TC100 (titanium diisopropoxybis(acetylacetonate) manufactured by Matsumoto Fine Chemical Co., Ltd.) and phenylboronic acid (manufactured by Tokyo Chemical Industry Co., Ltd.) are other components,

1,9-nonanediol diacrylate (LIGHT ACRYLATE 1.9ND-A manufactured by Kyoeisha Chemical Co., Ltd.) and tricyclodecanedimethanol diacrylate (LIGHT ACRYLATE DCP-A manufactured by Kyoeisha Chemical Co., Ltd.) are other monomers, and

IRGACURE 907 (manufactured by BASF) and KAYACURE DETX-S (manufactured by Nippon Kayaku Co., Ltd.) are polymerization initiators.

1. A polarizing film comprising a polarizer and a cured resin layer formed on at least one surface of the polarizer by curing a curable resin composition, wherein
the curable resin composition contains a compound represented by formula (1): 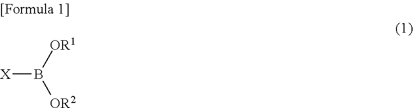
wherein X represents a functional group comprising a reactive group, and R¹ and R² each independently represent a hydrogen atom or an optionally substituted, aliphatic hydrocarbon, aryl, or heterocyclic group.

2. The polarizing film according to claim 1, wherein the compound represented by formula (1) is represented by formula (1′): 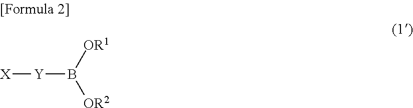
wherein Y is a phenylene group or an alkylene group, and X, R¹, and R² have the same meanings as defined above.

3. The polarizing film according to claim 1, wherein the compound represented by formula (1) has hydrogen atoms for both R¹ and R².

4. The polarizing film according to claim 1, wherein the reactive group of the compound represented by formula (1) is at least one reactive group selected from the group consisting of a vinyl group, a (meth)acrylic group, a styryl group, a (meth)acrylamide group, a vinyl ether group, an epoxy group, an oxetane group, and a mercapto group.

5. The polarizing film according to claim 1, wherein the curable resin composition contains a compound represented by formula (2): 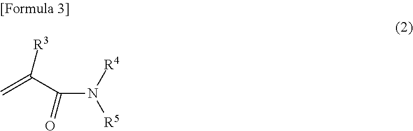
wherein R³ is a hydrogen atom or a methyl group, R⁴ and R⁵ are each independently a hydrogen atom, an alkyl group, a hydroxyalkyl group, an alkoxyalkyl group, or a cyclic ether group, and R⁴ and R⁵ may form a heterocyclic ring.

6. The polarizing film according to claim 1, further comprising a transparent protective film, wherein the cured resin layer is an adhesive layer, and the transparent protective film is provided on at least one surface of the polarizer with the adhesive layer interposed between the polarizer and the transparent protective film.

7. An optical film comprising a laminate comprising at least one piece of the polarizing film according to claim 1.

8. An image display device comprising the polarizing film according to claim 1.

9. A method for manufacturing a polarizing film comprising a polarizer and a cured resin layer formed on at least one surface of the polarizer by curing a curable resin composition, the method comprising the steps of:
applying the curable resin composition to at least one surface of the polarizer; and
curing the curable resin composition with active energy rays applied from a polarizer surface side or a curable resin composition-coated surface side, wherein
the curable resin composition contains a compound represented by formula (1): 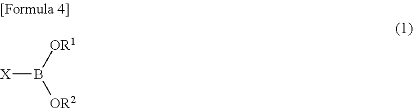
wherein X represents a functional group comprising a reactive group, and R¹ and R² each independently represent a hydrogen atom or an optionally substituted, aliphatic hydrocarbon, aryl, or heterocyclic group.

10. The method according to claim 9, wherein the compound represented by formula (1) is represented by formula (1′): 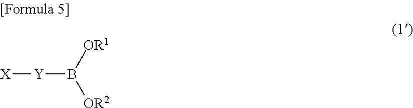
wherein Y is a phenylene group or an alkylene group, and X, R¹, and R² have the same meanings as defined above.

11. The method according to claim 9, wherein the cured resin layer is an adhesive layer and the polarizing film further comprises a transparent protective film provided on at least one surface of the polarizer with the adhesive layer interposed between the polarizer and the transparent protective film, the method comprising the steps of:
applying the curable resin composition to a surface of at least one of the polarizer and the transparent protective film;
laminating the polarizer and the transparent protective film; and
bonding the polarizer and the transparent protective film together with an adhesive layer formed therebetween by curing the curable resin composition with active energy rays applied from a polarizer surface side or a transparent protective film surface side.
